(19) United States
(12) Patent Application Publication
(10) Pub. No.: US 2019/0230320 A1
(43) Pub. Date: Jul. 25, 2019

(54) CROWD MONITORING DEVICE AND CROWD MONITORING SYSTEM

(71) Applicant: MITSUBISHI ELECTRIC CORPORATION, Tokyo (JP)

(72) Inventors: Yoshimi MORIYA, Tokyo (JP); Ryoji HATTORI, Tokyo (JP); Kazuyuki MIYAZAWA, Tokyo (JP); Shunichi SEKIGUCHI, Tokyo (JP)

(73) Assignee: MITSUBISHI ELECTRIC CORPORATION, Tokyo (JP)

(21) Appl. No.: 16/316,530

(22) PCT Filed: Jul. 14, 2016
(86) PCT No.: PCT/JP2016/070840

§ 371 Date: Jan. 9, 2019

(51) Int. Cl. H04N 7/18; G06T 7/60

(52) U.S. Cl. CPC H04N 7/18; G06T 7/60

(57) ABSTRACT

Included are a parameter deriving unit (13) for deriving, based on sensor data indicating an object group detected by sensors (401, 402, . . . , 40p) and having information regarding a spatial feature quantity using a real space as a reference, a state parameter indicating a state feature quantity of the object group indicated by the sensor data, and a crowd state predicting unit (14) for creating, on the basis of the state parameter derived by the parameter deriving unit (13), predicted data predicting a state of the object group.

### TECHNICAL FIELD

The present invention relates to a crowd monitoring device for predicting a flow of a crowd and a crowd monitoring system.

### BACKGROUND ART

Conventionally, a technique for estimating the degree of congestion, a flow of people, or the like is known.

For example, Patent Literature 1 discloses a technique for estimating the degree of congestion, a flow of people, or the like considering not only fixed spatial information but also a dynamic causal relationship between sensors, such as railroad schedule information, station entrance/exit history information, and the like, in a station platform, a concourse, or the like.

### CITATION LIST

### Patent Literatures

Patent Literature 1: JP 2013-116676 A

### SUMMARY OF INVENTION

### Technical Problem

However, in the technique as disclosed in Patent Literature 1, for example, it is necessary to prepare a database of a history of a flow of people structuring a causal relationship between the degree of congestion and station entrance/exit history information or the like in advance, and there is a problem that it may be difficult to estimate a flow of people in an environment in which it is difficult to prepare a database of a history of a flow of people in advance, such as outdoor, in an indoor event venue.

The present invention has been achieved to solve the above problems, and an object of the present invention is to provide a crowd monitoring device capable of estimating the degree of congestion or a flow of a crowd in an environment in which the degree of congestion or the flow of a crowd cannot be grasped in advance, and a crowd monitoring system.

### Solution to Problem

The crowd monitoring device according to the present invention includes: a parameter deriving unit for deriving, based on sensor data indicating an object group detected by a sensor and having information regarding a spatial feature quantity using a real space as a reference, a state parameter indicating a state feature quantity of the object group indicated by the sensor data; and a crowd state predicting unit for creating, based on the state parameter derived by the parameter deriving unit, predicted data predicting a state of the object group.

### Advantageous Effects of Invention

According to the present invention, it is possible to estimate the degree of congestion or a flow of a crowd in an environment in which the degree of congestion or the flow of a crowd cannot be grasped in advance.

### BRIEF DESCRIPTION OF DRAWINGS

FIG. 1 is a configuration diagram of a security supporting system including a crowd monitoring device according to a first embodiment of the present invention.

FIG. 2 is a configuration diagram of a sensor constituting the security supporting system of the first embodiment.

FIG. 3 is a diagram for explaining a detailed configuration of an image analyzing unit in the first embodiment.

FIG. 4 is a configuration diagram of the crowd monitoring device according to the first embodiment of the present invention.

FIG. 5 is a flowchart for explaining operation of a sensor in the first embodiment.

FIG. 6 is a flowchart for explaining an example of operation of first image analysis processing in step ST502 of FIG. 5.

FIG. 7 is a diagram illustrating an example of an image obtained by a scale estimating unit performing scale estimation of an object on an input image in the first embodiment.

FIG. 8 is a flowchart for explaining an example of operation of second image analysis processing in step ST503 of FIG. 5.

FIG. 9 is a diagram illustrating an example of an image obtained by a pattern analyzing unit analyzing a code pattern on the input image exemplified in FIG. 7 in the first embodiment.

FIG. 10 is a diagram illustrating an example of a display apparatus for displaying a spatial code pattern PNx in the first embodiment.

FIG. 11 is a diagram illustrating an example of an image obtained by the pattern analyzing unit estimating positioning information regarding an object in the first embodiment.

FIG. 12 is a diagram illustrating an example of a format of a spatial descriptor in the first embodiment.

FIG. 13 is a diagram illustrating an example of a format of a spatial descriptor in the first embodiment.

FIG. 14 is a diagram illustrating an example of a format of a descriptor of GNSS information, that is, a format of a geographical descriptor in the first embodiment.

FIG. 15 is a diagram illustrating an example of a format of a descriptor of GNSS information, that is, a format of a geographical descriptor in the first embodiment.

FIG. 16 is a flowchart for explaining operation of the crowd monitoring device according to the first embodiment of the present invention.

FIG. 17 is a diagram for explaining an example of operation of a crowd parameter deriving unit specifying a crowd region in the first embodiment.

FIG. 18 is a diagram for explaining an example of a method for a time crowd state predicting unit of a crowd state predicting unit predicting a future crowd state and creating “temporally predicted data” in the first embodiment.

FIGS. 19A and 19B are diagrams for explaining an example of an image in which visual data generated by a state presenting unit is displayed on a display device of an external apparatus.

FIGS. 20A and 20B are diagrams for explaining another example of the image in which visual data generated by the state presenting unit is displayed on a display device of an external apparatus.

FIG. 21 is a diagram for explaining still another example of the image in which visual data generated by the state presenting unit is displayed on a display device of an external apparatus.

FIGS. 22A and 22B are diagrams illustrating an example of a hardware configuration of the crowd monitoring device according to the first embodiment of the present invention.

FIGS. 23A and 23B are diagrams illustrating an example of a hardware configuration of an image processing device according to the first embodiment of the present invention.

FIG. 24 is a configuration diagram of a crowd monitoring device according to a second embodiment of the present invention.

FIG. 25 is a diagram for explaining an example in which a time crowd state predicting unit sets a moving direction of a crowd to two directions, detected as “type of crowd action” to be “counter flow” in a third embodiment.

FIG. 26 is a diagram for explaining an example of a region for which the number of passing person is calculated in the third embodiment.

FIG. 27 is a diagram illustrating an example of an image of a flow rate calculating region in a shot image and a predetermined line in the flow rate calculating region in the third embodiment.

FIG. 28 is a diagram for explaining an example of a relationship between the number of pixels counted as having a flow obtained by moving a predetermined line in an “IN” direction and the density of a crowd in the third embodiment.

FIGS. 29A and 29B are diagrams for explaining an example of a relationship between the number of pixels obtained in a shot image and the density of a crowd in the third embodiment.

FIG. 30 is a diagram illustrating an example of a relationship between a value obtained by dividing the counted number of pixels by the number of pixels per person and a flow rate in the “IN” direction in the third embodiment.

FIG. 31 is a processing flow diagram of crowd flow rate calculation processing executed for one image frame in the third embodiment.

FIG. 32 is a diagram illustrating an example of a state in which people are arranged in a grid shape as a model of a positional relationship of a crowd in the third embodiment.

FIG. 33 is a diagram for explaining an example in which the appearance and the area of a foreground region vary depending on an inclination of a grid-shaped model with respect to an optical axis direction of a camera in the third embodiment.

FIG. 34 is a diagram for explaining an example in which the appearance and the area of a foreground region vary depending on an inclination of a grid-shaped model with respect to an optical axis direction of a camera in the third embodiment.

FIG. 35 is a diagram for explaining an example in which a user manually designates a parameter for approximating a road surface in a measurement target region with a plane in the third embodiment.

FIG. 36 is a diagram for explaining a person region in which a person region on a far side of a camera image is hidden by a person located in front in the third embodiment.

FIG. 37 is a diagram for explaining an example of a configuration in which an image processing device can accumulate information regarding a descriptor.

### DESCRIPTION OF EMBODIMENTS

Hereinafter, embodiments of the present invention will be described in detail with reference to the drawings.

### First Embodiment

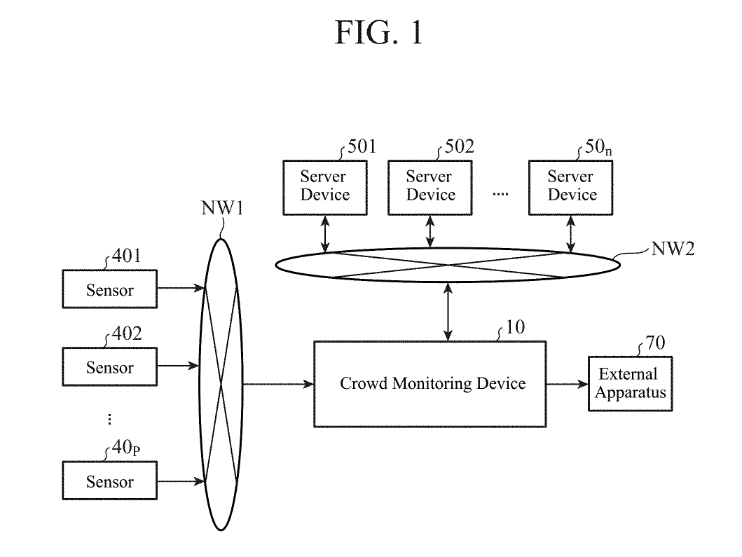

FIG. 1 is a configuration diagram of a security supporting system 1 including a crowd monitoring device 10 according to a first embodiment of the present invention.

Here, as an example, the security supporting system 1 will be exemplified below as a crowd monitoring system to which the crowd monitoring device 10 according to the first embodiment of the present invention is applied.

The security supporting system 1 in the first embodiment can be operated, for example, supposing a crowd existing on facility premises or in an event venue or an urban area and a security officer placed in these places as a target of use.

Congestion may often occur in a place where many people in a group, that is, a crowd including a security officer gathers, such as facility premises, an event venue, or an urban area. Congestion damages comfort of a crowd at a place where the crowd exists, overcrowded congestion causes an accident involving the crowd, and therefore avoidance of congestion by appropriate security is extremely important. In addition, it is important in crowd security to quickly discover an injured person, a person in a bad physical condition, a weak person in traffic, and a person or a group that acts dangerously, and to provide appropriate security.

In the security supporting system in the first embodiment, for example, the crowd monitoring device 10 presents information indicating a crowd state and an appropriate security plan to a user as useful information for security support on the basis of a state estimated from image data acquired from imaging devices as sensors 401, 402, . . . , and 40p.

Incidentally, in the first embodiment, the user is assumed to be, for example, a crowd or a security guard who monitors a target area. Incidentally, in the first embodiment, the target area refers to a range which is a target for monitoring a crowd.

As illustrated in FIG. 1, the security supporting system 1 includes the crowd monitoring device 10, the sensors 401, 402, . . . , and 40p, server devices 501, 502, . . . , and 50n, and an external apparatus 70.

The sensors 401, 402, . . . , and 40p are connected to the crowd monitoring device 10 via a communication network NW1.

In FIG. 1, the three or more sensors 401, 402, . . . , and 40p are supposed to exist, but this is merely an example, and one or two sensors may be connected to the crowd monitoring device 10 via the communication network NW1.

The server devices 501, 502, . . . , and 50n are connected to the crowd monitoring device 10 via a communication network NW2.

In FIG. 1, the three or more server devices 501, 502, . . . , and 50n are supposed to exist, but this is merely an example, and one or two server devices may be connected to the crowd monitoring device 10 via the communication network NW2.

Examples of the communication networks NW1 and NW2 include a local area communication network such as a wired LAN or a wireless LAN, a dedicated line network connecting bases, and a wide area communication network such as the Internet. Incidentally, in the first embodiment, the communication networks NW1 and NW2 are configured to be different from each other, but the present invention is not limited thereto. The communication networks NW1 and NW2 may constitute a single communication network.

The sensors 401, 402, . . . , and 40p are distributed and disposed in a single target area or a plurality of target areas, and each of the sensors 401, 402, . . . , and 40p electrically or optically detects a state(s) of the target area(s) to generate a detection signal and performs signal processing on the detection signal to generate sensor data. This sensor data includes processed data indicating contents in which detection contents indicated by a detection signal are abstracted or compacted.

The sensors 401, 402, . . . , and 40p transmit the generated sensor data to the crowd monitoring device 10 via the communication network NW1.

In this first embodiment, the sensors 401, 402, . . . , and 40p are imaging devices such as cameras as an example, but the present invention is not limited thereto, and various types of sensors can be used as the sensors 401, 402, . . . , and 40p.

The types of the sensors 401, 402, . . . , and 40p are roughly classified into two types, that is, a fixed sensor installed at a fixed position and a moving sensor mounted on a moving object. Examples of the fixed sensor include an optical camera, a laser distance measuring sensor, an ultrasonic distance measuring sensor, a sound collecting microphone, a thermo camera, a night vision camera, and a stereo camera. Meanwhile, examples of the moving sensor include, in addition to the same type of sensor as the fixed sensor, a positioning meter, an acceleration sensor, and a vital sensor. By performing sensing while moving together with a crowd to be detected, that is, an object group to be sensed, the moving sensor can be mainly used for directly sensing movement and a state of the object group. In addition, a device for accepting input of subjective data indicating a result of observation of a state of an object group by a person may be used as a part of a sensor. This type of device can supply the subjective data as sensor data, for example, through a mobile communication terminal such as a smartphone or a wearable apparatus possessed by the person.

Note that these sensors 401, 402, . . . , and 40p may be constituted by only a single type of sensor, or may be constituted by a plurality of types of sensors.

Each of the sensors 401, 402, . . . , and 40p is installed at a position where a state of a target area can be electrically or optically detected, that is, here, at a position where a crowd can be detected, and can transmit a result of detecting the crowd according to necessity while the security supporting system 1 operates. The fixed sensor is installed, for example, in a street lamp, a utility pole, a ceiling, or a wall. The moving sensor is carried by a security guard or mounted on a moving object such as a security robot or a patrol vehicle. In addition, a sensor attached to a mobile communication terminal such as a smartphone or a wearable apparatus possessed by each individual constituting a crowd or a security guard may be used as the moving sensor. In this case, a framework of sensor data collection is desirably built in advance so that an application or software for sensor data collection is installed in advance in a mobile communication terminal possessed by each individual constituting a crowd as a security target or a security guard.

The server devices 501, 502, . . . , and 50n distribute social networking service/social networking site (SNS) information and public data such as public information. SNS refers to an exchange service or an exchange site that has a high real-time property and discloses contents posted by a user to the public, such as Twitter (registered trademark) or Facebook (registered trademark). The SNS information is information disclosed to the public by such a type of exchange service or exchange site. Examples of the public information include traffic information or weather information provided by an administrative unit such as a local government, a public transportation facility, or a weather station, and positional information regarding a user of an application for a smartphone provided by a service provider or the like.

The crowd monitoring device 10 grasps or predicts, on the basis of sensor data transmitted from the sensors 401, 402, . . . , and 40p distributed and disposed in a single target area or a plurality of target areas, a crowd state(s) in the target area(s).

When the crowd monitoring device 10 acquires public data distributed from the server devices 501, 502, . . . , and 50n on the communication network NW2, the crowd monitoring device 10 grasps or predicts a crowd state in a target area on the basis of the acquired sensor data and public data.

The crowd monitoring device 10 derives, by calculation, information indicating a past, present, or future crowd state processed into a form easily understood by a user on the basis of the grasped or predicted crowd state in the target area and an appropriate security plan, and transmits the information indicating the past, present, or future state and the security plan to the external apparatus 70 as useful information for security support.

The external apparatus 70 is, for example, a dedicated monitoring apparatus, a general purpose personal computer (PC), an information terminal such as a tablet terminal or a smartphone, or a large display or a speaker which can be viewed by an unspecified number of people.

The external apparatus 70 outputs the information useful for security support including the information indicating the past, present, or future state and the security plan, transmitted from the crowd monitoring device 10. As a method for outputting the information useful for security support from the external apparatus 70, for example, when the external apparatus 70 is a monitoring apparatus, the information may be displayed on a screen as an image, when the external apparatus 70 is a speaker, the information may be output as audio, when the external apparatus 70 is an information terminal, an information terminal may be vibrated by a vibrator, and an appropriate output method can be adopted depending on the form of the external apparatus 70.

By checking the information output from the external apparatus 70, a security guard or a crowd can grasp a present or future state of the crowd in a target area, a security plan, and the like.

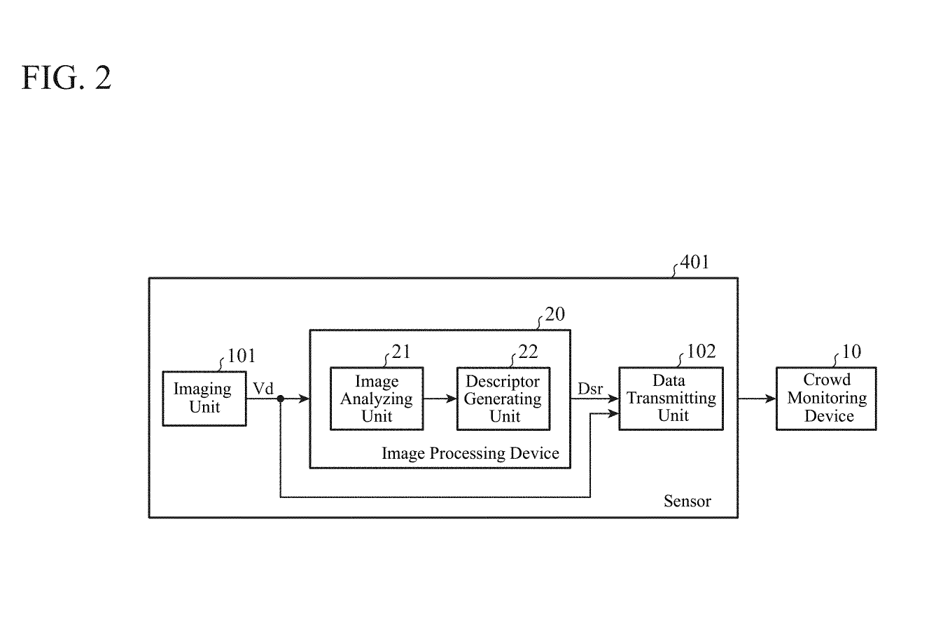

FIG. 2 is a configuration diagram of the sensor 401 constituting the security supporting system 1 of the first embodiment.

First, the configuration of the sensor 401 in the first embodiment will be described.

Incidentally, as described above, in the first embodiment, as an example, the sensor is assumed to be an imaging device such as a camera. FIG. 2 illustrates the configuration of the sensor 401 out of the sensors 401, 402, . . . , and 40p, but in the first embodiment, each of the sensors 402, . . . , and 40p is also assumed to have a similar configuration to the sensor 401 illustrated in FIG. 2.

In the first embodiment, each of the sensors 401, 402, . . . , and 40p images a target area, analyzes a shot image, detects an object appearing in the shot image, generates descriptor data indicating a spatial, geographical, and visual feature quantity of the detected object, and transmits the descriptor data together with image data to the crowd monitoring device 10.

As illustrated in FIG. 2, the sensor 401 has an image processing device 20 mounted thereon, and includes an imaging unit 101 and a data transmitting unit 102.

Incidentally, here, as illustrated in FIG. 2, the image processing device 20 is mounted on the sensor 401, but the present invention is not limited thereto. The image processing device 20 may be disposed outside the sensor 401 and may be connected to the imaging unit 101 and the data transmitting unit 102 of the sensor 401 via a network.

The imaging unit 101 images a target area and outputs image data (Vd in FIG. 2) of the shot image to the image processing device 20. Note that the image data imaged and output by the imaging unit 101 includes still image data or moving image data.

The imaging unit 101 includes an imaging optical system for forming an optical image of a subject existing in a target area, a solid-state image sensor for converting the optical image into an electric signal, and an encoder circuit for compressing and encoding the electric signal as still image data or moving image data. As the solid-state image sensor, for example, it is only required to use a charge-coupled device (CCD) or a complementary metal-oxide semiconductor (CMOS) element.

In a case where the imaging unit 101 compresses and encodes output of the solid-state image sensor as image data, for example, the imaging unit 101 can generate a compressed and encoded moving image stream in accordance with a streaming method such as moving picture experts group 2 transport stream (MPEG-2 TS), real-time transport protocol/real time streaming protocol (RTP/RTSP), MPEG media transport (MMT), or dynamic adaptive streaming over HTTP (DASH). Note that the streaming method used in the first embodiment is not limited to MPEG-2 TS, RTP/RTSP, MMT, and DASH. However, in any of the streaming methods, identifier information capable of uniquely separating moving image data included in a moving image stream by the image processing device 20 needs to be multiplexed in the moving image stream.

The image processing device 20 performs image analysis on image data acquired from the imaging unit 101, and outputs a spatial or geographical descriptor (Dsr in FIG. 2) indicating the analysis result in association with the image data to the data transmitting unit 102.

The detailed configuration of the image processing device 20 will be described later.

The data transmitting unit 102 associates and multiplexes the image data output by the imaging unit 101 and the descriptor output by the image processing device 20 with each other and transmits the data as sensor data to the crowd monitoring device 10 via the communication network NW1.

The detailed configuration of the image processing device 20 will be described.

As illustrated in FIG. 2, the image processing device 20 includes an image analyzing unit 21 and a descriptor generating unit 22.

The image analyzing unit 21 acquires image data from the imaging unit 101 and performs image analysis. The image analyzing unit 21 outputs the analysis result to the descriptor generating unit 22. Specifically, the image processing device 20 includes an input interface device (not illustrated), and the input interface device accepts image data output from the imaging unit 101 and outputs the accepted image data to the image analyzing unit 21. That is, the image analyzing unit 21 acquires the image data output from the imaging unit 101 via the input interface device.

The descriptor generating unit 22 generates, based on an analysis result output by the image analyzing unit 21, a spatial or geographical descriptor indicating the analysis result. In addition to the spatial descriptor or the geographical descriptor, the descriptor generating unit 22 has a function of generating a known descriptor according to the MPEG standard, such as a visual descriptor indicating a feature quantity such as the color, the texture, the shape, the movement, or the face of an object. This known descriptor is defined in MPEG-7, for example, and therefore detailed description thereof will be omitted.

The descriptor generating unit 22 outputs information regarding the generated descriptor to the data transmitting unit 102. Specifically, the image processing device 20 includes an output interface device (not illustrated), and the output interface device outputs the information regarding the descriptor generated by the descriptor generating unit 22 to the data transmitting unit 102. That is, the descriptor generating unit 22 outputs the information regarding the descriptor to the data transmitting unit 102 via the output interface device.

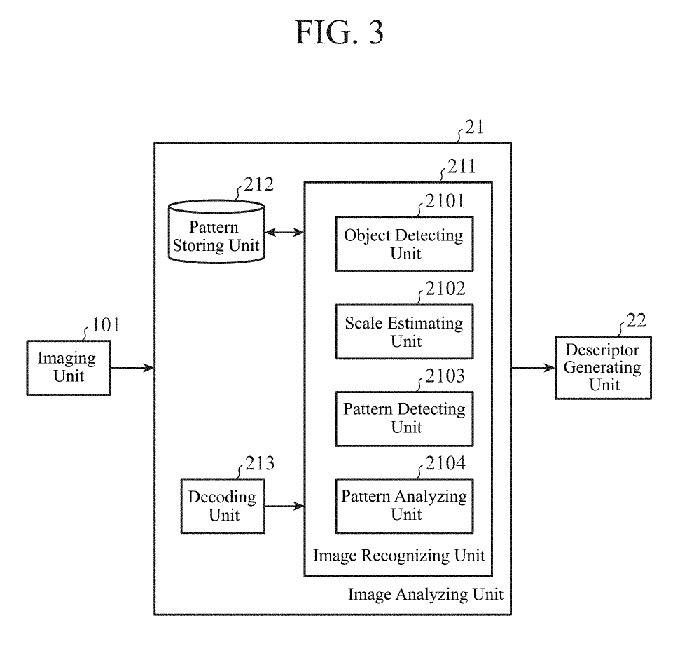

FIG. 3 is a diagram for explaining the detailed configuration of the image analyzing unit 21 in the first embodiment.

As illustrated in FIG. 3, the image analyzing unit 21 includes an image recognizing unit 211, a pattern storing unit 212, and a decoding unit 213.

The image recognizing unit 211 includes an object detecting unit 2101, a scale estimating unit 2102, a pattern detecting unit 2103, and a pattern analyzing unit 2104.

The decoding unit 213 acquires image data output by the imaging unit 101, and decodes compressed image data in accordance with the compression encoding method used by the imaging unit 101. The decoding unit 213 outputs the decoded image data as decoded data to the image recognizing unit 211.

The pattern storing unit 212 stores a pattern indicating features, for example, the planar shapes, the three-dimensional shapes, the sizes, and the colors of various objects such as a human body including a pedestrian, a traffic signal, a sign, an automobile, a bicycle, and a building. The pattern stored in the pattern storing unit 212 is determined in advance.

The object detecting unit 2101 of the image recognizing unit 211 analyzes a single input image or a plurality of input images indicated by the decoded data acquired from the decoding unit 213 and detects an object appearing in the input image(s). Specifically, by comparing the input image(s) indicated by decoded data with the pattern stored in the pattern storing unit 212, the object detecting unit 2101 detects an object appearing in the input image(s).

The object detecting unit 2101 outputs information regarding the detected object to the scale estimating unit 2102 and the pattern detecting unit 2103.

The scale estimating unit 2102 of the image recognizing unit 211 estimates, as scale information, a spatial feature quantity of the object detected by the object detecting unit 2101 using a real space which is an actual imaging environment as a reference. As the spatial feature quantity of the object, a quantity indicating the physical dimensions of the object in the real space is preferably estimated. Hereinafter, the quantity indicating the physical dimensions of an object in the real space is simply referred to as “physical quantity”. The physical quantity of an object is, for example, the height or width of the object, or an average value of the heights or widths of the objects.

Specifically, the scale estimating unit 2102 acquires the physical quantity of the object detected by the object detecting unit 2101 with reference to data in the pattern storing unit 212. For example, in a case where the object is a traffic signal, a sign, or the like, the shape and the dimensions of the traffic signal, the sign, or the like are known, and therefore for example, a security guard who is a user stores numerical values of the shape and the dimensions of the traffic signal, the sign, or the like in the pattern storing unit 212 in advance. For example, in a case where the object is an automobile, a bicycle, a pedestrian, or the like, variation in numerical values of the shape and the dimensions of the automobile, the bicycle, the pedestrian, or the like is within a certain range, and therefore for example, a security guard who is a user stores average values of the shape and the dimensions of the automobile, the bicycle, the pedestrian, or the like in the pattern storing unit 212 in advance.

The scale estimating unit 2102 can estimate the posture of an object such as a direction in which the object faces as one of the spatial feature quantities.

In a case where the sensor 401 has a function of generating a three-dimensional image like a stereo camera or a distance measuring camera, an image imaged by the imaging unit 101 and decoded by the decoding unit 213 includes not only intensity information regarding an object but also depth information regarding the object. In this case, the scale estimating unit 2102 can acquire the depth information regarding the object as one of the physical quantities of the object detected by the object detecting unit 2101.

The pattern detecting unit 2103 and the pattern analyzing unit 2104 of the image recognizing unit 211 estimate geographical information regarding the object detected by the object detecting unit 2101. The geographical information is, for example, positioning information indicating the position of the object on the earth.

The pattern detecting unit 2103 detects a code pattern in an image indicated by image data decoded by the decoding unit 213. The code pattern is detected near the object detected by the object detecting unit 2101, and is for example, a spatial code pattern such as a two-dimensional code or a time-series code pattern such as a pattern in which light blinks in accordance with a predetermined rule. Alternatively, a combination of the spatial code pattern and the time-series code pattern may be used. The pattern detecting unit 2103 outputs the detected code pattern to the pattern analyzing unit 2104.

The pattern analyzing unit 2104 analyzes the code pattern acquired from the pattern detecting unit 2103 and detects positioning information. The pattern analyzing unit 2104 outputs the detected positioning information to the descriptor generating unit 22.

Next, the configuration of the crowd monitoring device 10 according to the first embodiment of the present invention will be described.

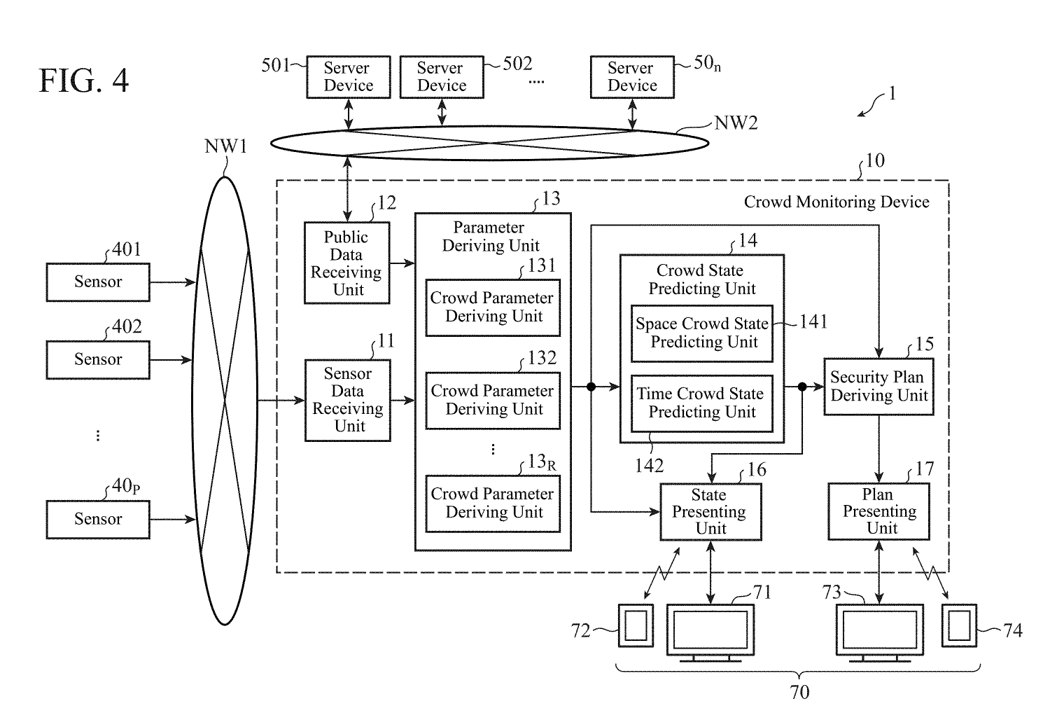

FIG. 4 is a configuration diagram of the crowd monitoring device 10 according to the first embodiment of the present invention.

As illustrated in FIG. 4, the crowd monitoring device 10 includes a sensor data receiving unit 11, a public data receiving unit 12, a parameter deriving unit 13, a crowd state predicting unit 14, a security plan deriving unit 15, a state presenting unit 16, and a plan presenting unit 17.

The parameter deriving unit 13 includes crowd parameter deriving units 131, 132, . . . , and 13R.

The crowd state predicting unit 14 includes a space crowd state predicting unit 141 and a time crowd state predicting unit 142.

The sensor data receiving unit 11 receives sensor data transmitted from the sensors 401, 402, . . . , and 40p. The sensor data receiving unit 11 outputs the received sensor data to the parameter deriving unit 13.

The public data receiving unit 12 receives public data disclosed from the server devices 501, 502, . . . , and 50n via the communication network NW2. The public data receiving unit 12 outputs the received public data to the parameter deriving unit 13.

The parameter deriving unit 13 acquires the sensor data output from the sensor data receiving unit 11, and derives a state parameter indicating a crowd state feature quantity detected by the sensors 401, 402, . . . , and 40p on the basis of the acquired sensor data. In a case where the parameter deriving unit 13 has acquired the public data output from the public data receiving unit 12, the parameter deriving unit 13 derives a state parameter indicating a crowd state feature quantity detected by the sensors 401, 402, . . . , and 40p on the basis of the sensor data acquired from the sensor data receiving unit 11 and the public data acquired from the public data receiving unit 12.

The crowd parameter deriving units 131, 132, . . . , and 13R of the parameter deriving unit 13 each analyze the sensor data output from the sensor data receiving unit 11 or the public data output from the public data receiving unit 12, and derive R types of state parameters (R is an integer equal to or more than 3) indicating a crowd state feature quantity. Incidentally, here, as illustrated in FIG. 4, the number of the crowd parameter deriving units 131 to 13R is equal to or more than 3, but the present invention is not limited thereto, and one or two crowd parameter deriving units may be used. The parameter deriving unit 13 outputs the derived state parameter to the crowd state predicting unit 14, the security plan deriving unit 15, and the state presenting unit 16.

The crowd state predicting unit 14 predicts a crowd state on the basis of the present or past state parameter output from the parameter deriving unit 13.

The space crowd state predicting unit 141 of the crowd state predicting unit 14 predicts a crowd state of an area where no sensor is installed on the basis of the state parameter output from the parameter deriving unit 13. The space crowd state predicting unit 141 outputs data indicating the prediction result of the crowd state of the area where no sensor is installed to the security plan deriving unit 15 and the state presenting unit 16. Here, the data indicating the prediction result of the crowd state of the area where no sensor is installed is referred to as “spatially predicted data”.

The time crowd state predicting unit 142 of the crowd state predicting unit 14 predicts a future crowd state on the basis of the state parameter output from the parameter deriving unit 13. The time crowd state predicting unit 142 outputs data indicating the prediction result of the future crowd state to the security plan deriving unit 15 and the state presenting unit 16. Here, the data indicating the prediction result of the future crowd state is referred to as “temporally predicted data”.

The security plan deriving unit 15 derives a security plan draft on the basis of the state parameter output from the parameter deriving unit 13 and information regarding the future crowd state output from the crowd state predicting unit 14. The security plan deriving unit 15 outputs information regarding the derived security plan draft to the plan presenting unit 17.

On the basis of the state parameter output from the parameter deriving unit 13 and the information regarding the crowd state output from the crowd state predicting unit 14, the state presenting unit 16 generates visual data or acoustic data representing a past state, a present state, and a future state of a crowd in a user-friendly format. Note that the present state includes a state that changes in real time.

The state presenting unit 16 transmits the generated visual data or acoustic data to external apparatuses 71 and 72 and causes the external apparatuses 71 and 72 to output the visual data or the acoustic data as an image or audio.

The plan presenting unit 17 acquires information regarding the security plan draft output from the security plan deriving unit 15 and generates visual data or acoustic data representing the acquired information in a user-friendly format.

The plan presenting unit 17 transmits the generated visual data or acoustic data to external apparatuses 73 and 74 and causes the external apparatuses 73 and 74 to output the visual data or the acoustic data as an image or audio.

Incidentally, here, the crowd monitoring device 10 includes the public data receiving unit 12, but the present invention is not limited thereto, and the crowd monitoring device 10 does not have to include the public data receiving unit 12.

Operation will be described.

First, operation of the sensors 401, 402, . . . , and 40p constituting the security supporting system 1 of the first embodiment for transmitting sensor data to the crowd monitoring device 10 via the communication network NW1 will be described.

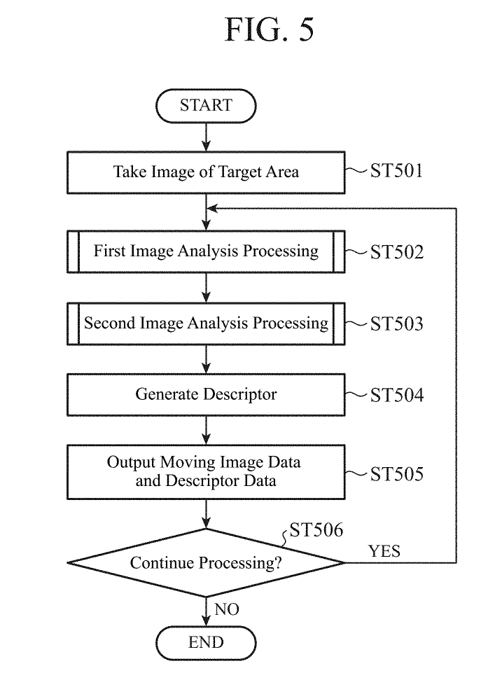

FIG. 5 is a flowchart for explaining operation of the sensor 401 in the first embodiment. Incidentally, here, the operation of the sensor 401 will be described as a representative. The operation of each of the sensors 402 to 40p is similar to the operation of the sensor 401, and therefore duplicate description will be omitted.

The imaging unit 101 images a target area and outputs image data of the shot image to the image analyzing unit 21 of the image processing device 20 (step ST501).

The image analyzing unit 21 executes first image analysis processing (step ST502).

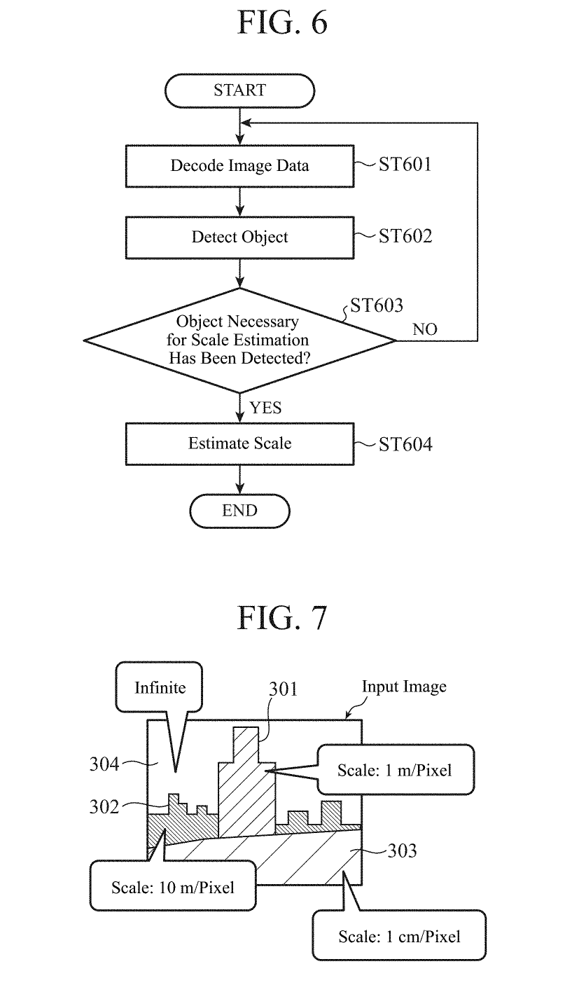

Here, FIG. 6 is a flowchart for explaining an example of operation of the first image analysis processing in step ST502 of FIG. 5.

The decoding unit 213 of the image analyzing unit 21 acquires the image data output from the imaging unit 101 in step ST501 of FIG. 5, and decodes the compressed image data according to the compression encoding method used in the imaging unit 101 (step ST601). The decoding unit 213 outputs the decoded image data as decoded data to the image recognizing unit 211.

The object detecting unit 2101 of the image recognizing unit 211 analyzes a single input image or a plurality of input images indicated by the decoded data acquired from the decoding unit 213 and detects an object appearing in the input image(s) (step ST602). Specifically, by comparing the input image(s) indicated by decoded data with the pattern stored in the pattern storing unit 212, the object detecting unit 2101 detects an object appearing in the input image(s).

Here, a detection target of the object detected by the object detecting unit 2101 is desirably, for example, an object the size and the shape of which are known, such as a traffic signal or a sign, or an object which appears in a moving image in various forms and the average size of which coincides with a known average size with sufficient accuracy, such as an automobile, a bicycle, or a pedestrian. The posture and depth information regarding the object with respect to a screen may be detected. The object detecting unit 2101 outputs information regarding the detected object to the scale estimating unit 2102 and the pattern detecting unit 2103 together with the decoded data acquired from the decoding unit 213.

On the basis of the information regarding the object detected by the object detecting unit 2101 in step ST602, the scale estimating unit 2102 of the image recognizing unit 211 estimates a spatial feature quantity of the object, that is, determines whether an object necessary for estimating scale information has been detected (step ST603). Note that the estimation of the scale information is also referred to as “scale estimation”. Details of “scale estimation” will be described later.

If it is determined in step ST603 that an object necessary for scale estimation has not been detected (“NO” in step ST603), the process returns to step ST601. At this time, the scale estimating unit 2102 outputs a decoding instruction to the decoding unit 213. When the decoding unit 213 acquires the decoding instruction, the decoding unit 213 acquires new image data from the imaging unit 101 and decodes the image data.

If it is determined in step ST603 that an object necessary for scale estimation has been detected (“YES” in step ST603), the scale estimating unit 2102 performs scale estimation for the object acquired from the object detecting unit 2101 (step ST604). Here, as an example, it is assumed that the scale estimating unit 2102 estimates the physical dimensions per pixel as scale information regarding the object.

When an object is detected by the object detecting unit 2101, the scale estimating unit 2102 acquires information regarding the object detected by the object detecting unit 2101, first compares the shape of the acquired object with the shape of an object stored in the pattern storing unit 212, and specifies an object having a shape coinciding with the shape of the acquired object among the objects stored in the pattern storing unit 212. Next, the scale estimating unit 2102 acquires the physical quantity stored in the pattern storing unit 212 in association with the specified object from the pattern storing unit 212.

Then, the scale estimating unit 2102 estimates scale information regarding the object detected by the object detecting unit 2101 on the basis of the acquired physical quantity and decoded data.

Specifically, for example, it is assumed that a circular sign appears on an input image indicated by the decoded data in a form opposite to an imaging device which is the sensor 401 and that the diameter of the sign corresponds to 100 pixels on the image indicated by the decoded data. In addition, it is assumed that the pattern storing unit 212 stores information that the diameter of the sign is 0.4 m as a physical quantity. First, the object detecting unit 2101 detects the sign by comparing the shapes, and acquires a value of 0.4 m as a physical quantity.

The scale estimating unit 2102 estimates that the scale of the sign detected by the object detecting unit 2101 is 0.004 m/pixel on the input image on the basis of information that the sign corresponds to 100 pixels on the input image and information that the diameter of the sign stored in the pattern storing unit 212 is 0.4 m.

FIG. 7 is a diagram illustrating an example of an image obtained by the scale estimating unit 2102 performing scale estimation of an object on an input image in the first embodiment.

In FIG. 7, it is assumed that building objects 301 and 302, a structure object 303, and a background object 304 are detected on the input image indicated by the decoded data, that is, on the image imaged by the imaging unit 101.

It is illustrated that scale information regarding the building object 301 is estimated to be 1 m/pixel as a result of scale estimation by the scale estimating unit 2102, scale information regarding the other building object 302 is estimated to be 10 m/pixel as a result of scale estimation by the scale estimating unit 2102, and scale information regarding the structure object 303 is estimated to be 1 cm/pixel as a result of scale estimation by the scale estimating unit 2102. As for the background object 304, since a distance from the imaging unit 101 to the background is regarded as being infinite in a real space, it is illustrated that the scale estimating unit 2102 estimates scale information regarding the background object 304 to be infinite. Incidentally, as for the background, it is only required to store information for setting dimensional information to infinity in the pattern storing unit 212 in advance.

For example, in a case where the object detected by the object detecting unit 2101 is a moving object that moves on the ground, such as an automobile or a pedestrian, or an object existing on the ground and disposed at a substantially constant position from the ground, such as a guardrail, an area in which this type of object exists is highly likely to be an area in which the moving object can move and an area constrained onto a specific plane. Therefore, the scale estimating unit 2102 can detect a plane on which an automobile, a pedestrian, or the like moves on the basis of the constraint condition, and also can derive a distance to the plane on the basis of estimated values of the physical dimensions of the object such as the automobile or the pedestrian and information regarding the average dimensions of the automobile, the pedestrian, or the like. Therefore, even in a case where the scale information regarding all the objects appearing in the input image cannot be estimated, it is possible to detect an area of a point where an object appears or an area important as a target for acquiring the scale information, such as a road, without a special sensor.

As described above, the decoding unit 213, the object detecting unit 2101 of the image recognizing unit 211, and the scale estimating unit 2102 perform the first image analysis processing.

Incidentally, here, if an object necessary for scale estimation is not detected (“NO” in step ST603), the process returns to step ST601, and subsequent processing is repeated, but the present invention is not limited thereto. The process returns to step ST601, it is determined whether an object necessary for scale estimation has been detected (step ST603), and if it is determined that an object necessary for scale estimation has not been detected even after a lapse of a predetermined period of time, that is, if processing in steps ST601 to ST603 is repeated and a predetermined period of time has elapsed, the first image analysis processing may be ended.

Return to the flowchart of FIG. 5.

After completion of the first image analysis processing (step ST502), the image recognizing unit 211 executes a second image analysis processing (step ST503).

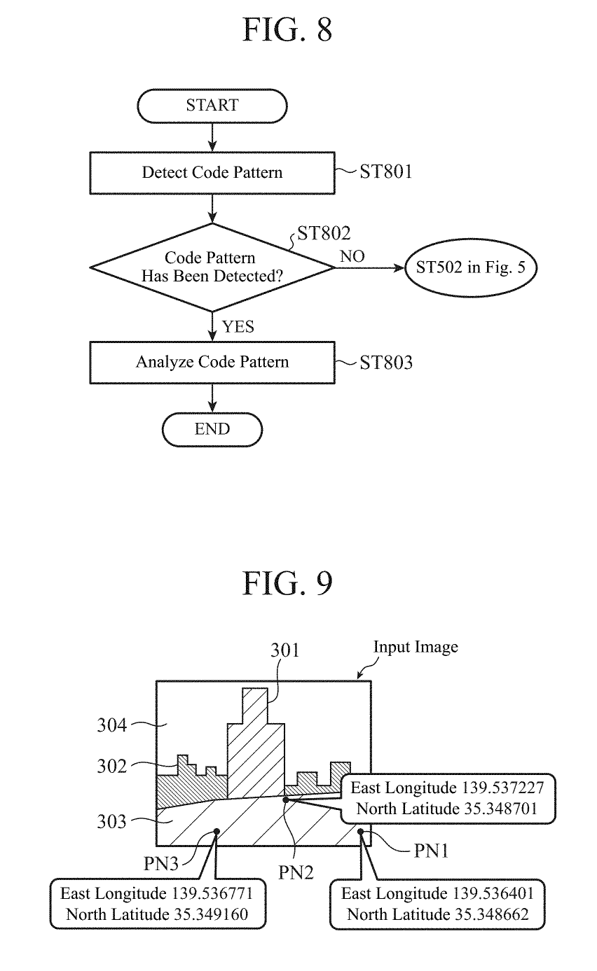

Here, FIG. 8 is a flowchart for explaining an example of operation of the second image analysis processing in step ST503 of FIG. 5.

The pattern detecting unit 2103 acquires decoded data from the decoding unit 213 (refer to step ST501 of FIG. 5), searches for an input image indicated by the decoded data acquired, and detects a code pattern from the image (step ST801).

The pattern detecting unit 2103 outputs information regarding the detected code pattern to the pattern analyzing unit 2104.

The pattern analyzing unit 2104 determines whether a code pattern has been detected on the basis of information regarding the code pattern acquired from the pattern detecting unit 2103 (step ST802).

If it is determined in step ST802 that no code pattern has been detected (“NO” in step ST802), the process returns to step ST502 of FIG. 5.

For example, if the pattern detecting unit 2103 cannot detect a code pattern in step ST801, the pattern detecting unit 2103 outputs information indicating that there is no code pattern to the pattern analyzing unit 2104. In this case, the pattern analyzing unit 2104 determines that no code pattern has been detected.

If it is determined in step ST802 that a code pattern has been detected (“YES” in step ST802), the pattern analyzing unit 2104 analyzes information regarding the code pattern acquired from the pattern detecting unit 2103 and estimates positioning information (step ST803). The pattern analyzing unit 2104 outputs the estimated positioning information to the descriptor generating unit 22.

FIG. 9 is a diagram illustrating an example of an image obtained by the pattern analyzing unit 2104 analyzing a code pattern on an input image exemplified in FIG. 7 in the first embodiment.

In FIG. 9, it is assumed that code patterns PN1, PN2, and PN3 are detected on an input image indicated by decoded data, that is, on the image imaged by the imaging unit 101.

The pattern analyzing unit 2104 obtains absolute coordinate information of latitude and longitude indicated by each code pattern as an analysis result of the code patterns PN1, PN2, and PN3. In FIG. 9, each of the code patterns PN1, PN2, and PN3 illustrated in a dot shape is a spatial pattern such as a two-dimensional code, a time-series pattern such as a light-blinking pattern, or a combination thereof. The pattern analyzing unit 2104 detects positioning information by analyzing the code patterns PN1, PN2, and PN3 appearing in the input image.

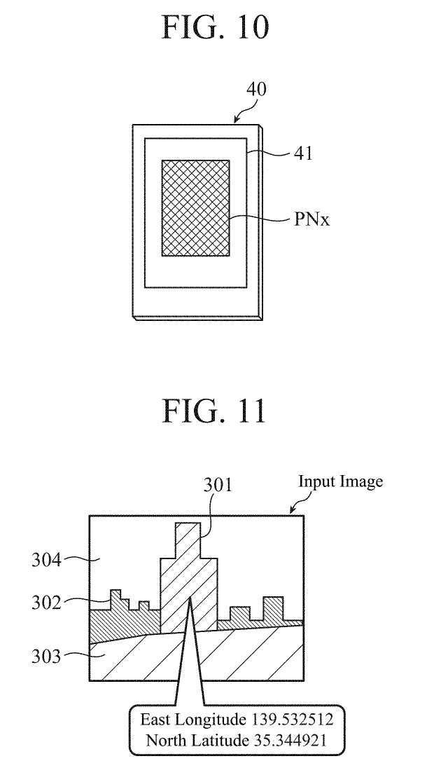

FIG. 10 is a diagram illustrating an example of a display apparatus 40 for displaying a spatial code pattern PNx in the first embodiment. The display apparatus 40 illustrated in FIG. 10 has a function of receiving a navigation signal by the global navigation satellite system (GNSS), measuring the current position of the display apparatus 40 on the basis of this navigation signal, and displaying a code pattern PNx indicating the positioning information on a display screen 41. By disposing such a display apparatus 40 near an object, as illustrated in FIG. 11, the pattern detecting unit 2103 can detect a code pattern, and the pattern analyzing unit 2104 can detect positioning information regarding an object on the basis of the code pattern detected by the pattern detecting unit 2103.

Note that positioning information by GNSS is also called GNSS information. As the GNSS, for example, a global positioning system (GPS) operated by the United States, a global navigation satellite system (GLONASS) operated by the Russian Federation, a Galileo system operated by the European Union, or a quasi-zenith satellite system operated by Japan can be used.

As described above, the second image analysis processing is performed by the pattern detecting unit 2103 and the pattern analyzing unit 2104 of the image recognizing unit 211.

Incidentally, here, if it is determined that no code pattern has been detected (“NO” in step ST802), the process returns to step ST502 of FIG. 5 and subsequent processing is repeated, but the present invention is not limited thereto. The process returns to step ST502, it is determined whether a code pattern has been detected (step ST802), and if it is determined that a code pattern has not been detected even after a lapse of a predetermined period of time, that is, if processing in steps ST502 to ST802 is repeated and a predetermined period of time has elapsed, the second image analysis processing may be ended.

Return to the flowchart of FIG. 5.

After completion of the second image analysis processing (step ST503), the descriptor generating unit 22 generates a spatial descriptor (Dsr illustrated in FIG. 2) representing scale information estimated by the scale estimating unit 2102 in the first image processing and a geographical descriptor (Dsr illustrated in FIG. 2) representing positioning information estimated by the pattern analyzing unit 2104 in the second image processing (step ST504). Then, the descriptor generating unit 22 outputs the generated descriptor data and the image data imaged by the imaging unit 101 in association with each other to the data transmitting unit 102.

The data transmitting unit 102 transmits the image data associated with the descriptor data output from the descriptor generating unit 22 to the crowd monitoring device 10.

Here, the image data and the descriptor data transmitted to the crowd monitoring device 10 by the data transmitting unit 102 are stored in the crowd monitoring device 10, but in this case, the data is preferably stored in such a format that the data can access each other bidirectionally at high speed. The descriptor generating unit 22 may create an index table indicating a correspondence between the image data and the descriptor data and output the table to the data transmitting unit 102, and the data transmitting unit 102 may transmit the table to the crowd monitoring device 10. The crowd monitoring device 10 may constitute a database with the table. For example, in a case where the position of a specific image frame constituting image data is given, the descriptor generating unit 22 can add index information so as to be able to specify the storage position of the descriptor data corresponding to the position on the database at high speed. Index information may be created so as to facilitate easy access in the opposite direction thereto.

A control unit (not illustrated) of the image processing device 20 determines whether to continue processing (step ST506). Specifically, the control unit determines whether an input accepting unit (not illustrated) of the image processing device 20 has accepted an instruction to end image processing.

For example, in a case where a user such as a security guard does not need to monitor a target area and switches off an imaging device, the input accepting unit of the image processing device 20 accepts the information as an instruction to end image processing.

If it is determined in step ST506 that processing is to be continued (“YES” in step ST506), that is, if the input accepting unit has not accepted an instruction to end image processing, the process returns to step ST502, and subsequent processing is performed.

As a result, transmission of the image data associated with the descriptor data to the crowd monitoring device 10 is continued.

If it is determined in step ST506 that processing is not to be continued (“NO” in step ST506), that is, if the input accepting unit accepts an instruction to end image processing, processing is ended.

Here, the spatial descriptor and the geographical descriptor generated by the descriptor generating unit 22 in step ST504 of FIG. 5 will be described in detail with examples.

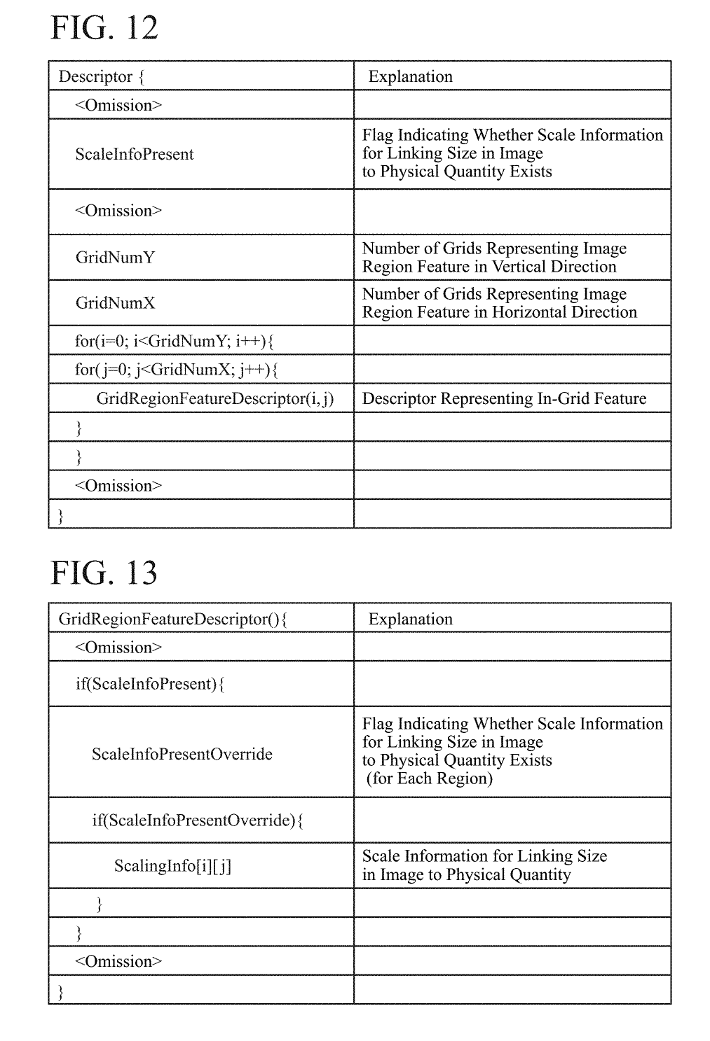

FIGS. 12 and 13 are diagrams illustrating examples of a format of a spatial descriptor in the first embodiment.

In the examples of FIGS. 12 and 13, a descriptor for each grid obtained by spatially dividing an image imaged by the imaging unit 101 into grid shapes is illustrated. As illustrated in FIG. 12, the flag “ScaleInfoPresent” is a flag indicating whether scale information for linking the size of a detected object to the physical quantity of the object exists. The shot image is divided into a plurality of image regions, that is, a plurality of grids in a spatial direction.

“GridNumX” indicates the number of grids in which an image region feature representing a feature of an object exists in a vertical direction, and “GridNumY” indicates the number of grids in which an image region feature representing the feature of an object exists in a horizontal direction. “GridRegionFeatureDescriptor (i, j)” is a descriptor representing a partial feature of an object of each grid, that is, an in-grid feature.

FIG. 13 is a diagram illustrating the contents of the descriptor “GridRegionFeatureDescriptor (i, j)” illustrated in FIG. 12. Referring to FIG. 13, “ScaleInfoPresentOverride” is a flag indicating whether scale information exists for each grid, that is, for each region.

“ScalingInfo[i][j]” is a parameter indicating scale information existing in the (i, j)ₜₕ grid (i is the number of the grid in a vertical direction, and j is the number of the grid in a horizontal direction). In this way, the scale information can be defined for each grid of an object appearing in a shot image. Incidentally, since a region where scale information cannot be acquired or scale information is unnecessary also exists, it is possible to designate whether description is performed per grid with the parameter “ScaleInfoPresentOverride”.

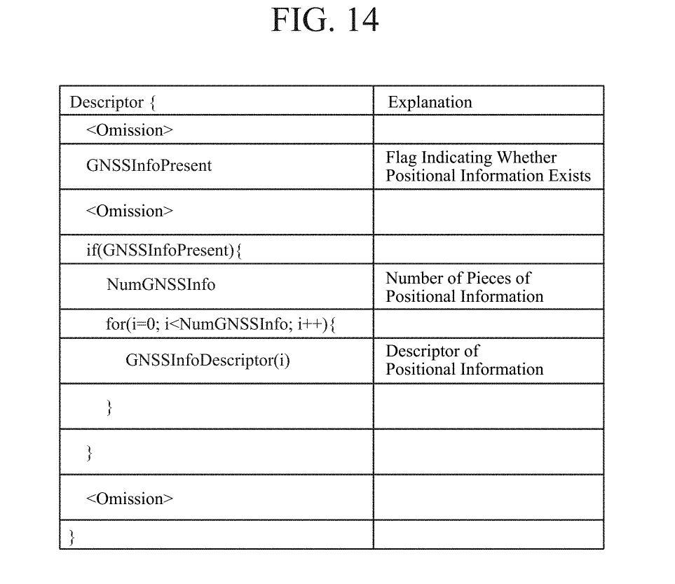

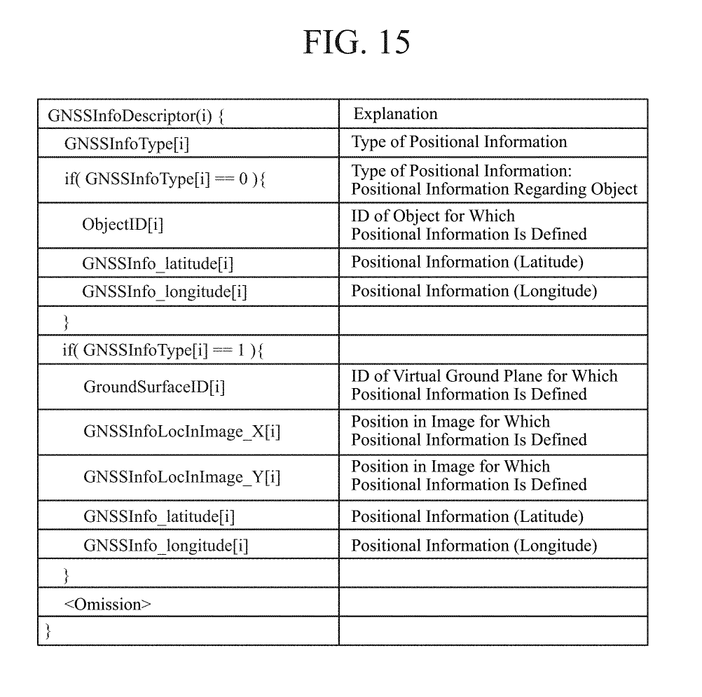

Next, each of FIGS. 14 and 15 is a diagram illustrating an example of a format of a descriptor of GNSS information, that is, a format of a geographical descriptor in the first embodiment.

Referring to FIG. 14, “GNSSInfoPresent” is a flag indicating whether positional information measured as GNSS information exists.

“NumGNSSInfo” is a parameter indicating the number of pieces of positional information.

“GNSSInfoDescriptor (i)” is a descriptor of the iₜₕ positional information. Since the positional information is defined by a point region in an input image, after the number of pieces of positional information is transmitted through the parameter “NumGNSSInfo”, GNSS information descriptors “GNSSInfoDescriptor (i)” corresponding to the number of pieces of the positional information are described.

FIG. 15 is a diagram illustrating the contents of the descriptor “GNSSInfoDescriptor (i)” illustrated in FIG. 14. Referring to FIG. 15, “GNSSInfoType [i]” is a parameter representing the type of the iₜₕ positional information. As the positional information, positional information regarding an object in a case of GNSSInfoType [i]=0 and positional information regarding an area other than the object in a case of GNSSInfoType [i]=1 can be described. Regarding the positional information regarding an object, “Object [i]” is an ID (identifier) of an object for which positional information is defined. For each object, “GNSSInfo_Latitude [i]” indicating latitude and “GNSSInfo_longitude [i]” indicating longitude are described.

Meanwhile, as for positional information other than an object, “Ground Surface ID [i]” illustrated in FIG. 15 is an ID (identifier) of a virtual ground plane on which positional information measured as GNSS information is defined, “GNSSInfoLocInImage_X[i]” is a parameter indicating the position for which positional information is defined in an image in the horizontal direction, and “GNSSInfoLocInImage_Y [i]” is a parameter indicating the position for which positional information is defined in an image in the vertical direction. “GNSSInfo_Latitude [i]” indicating latitude and “GNSSInfo_longitude [i]” indicating longitude are described for each ground plane. The positional information is information capable of mapping a specific plane appearing on a screen on a map in a case where an object is constrained to the plane. Therefore, the ID of the virtual ground plane where GNSS information exists is described. It is also possible to describe GNSS information for an object appearing in an image. This is based on assumption of application of using GNSS information in order to search for a landmark or the like.

Incidentally, the descriptors illustrated in FIGS. 12 to 15 are examples, and any information can be added thereto or deleted therefrom, and the order thereof or the configuration thereof can be changed.

As described above, the sensors 401, 402, . . . , and 40p constituting the security supporting system 1 of the first embodiment can transmit image data associating with a spatial descriptor of an object appearing in a shot image to the crowd monitoring device 10. By using a spatial descriptor as a search target, the crowd monitoring device 10 can perform association among a plurality of objects appearing in a plurality of shot images and having a spatial or spatiotemporally close relationship with high accuracy and with a low processing load. Therefore, for example, even in a case where the plurality of sensors 401, 402, . . . , and 40p images the same target area from different directions, by calculating the similarity among descriptors transmitted from the sensors 401, 402, . . . , and 40p, association among a plurality of objects appearing in shot images of the sensors 401, 402, . . . , and 40p can be performed with high accuracy. That is, in any image imaged from various directions, it is possible to grasp a relationship among a plurality of objects in one shot image. That is, a plurality of objects in one shot image can be detected as an object group.

In the first embodiment, as described above, the sensors 401, 402, . . . , and 40p can also transmit a geographical descriptor of an object appearing in a shot image associating with image data to the crowd monitoring device 10. By using a geographical descriptor together with a spatial descriptor as a search target, the crowd monitoring device 10 can perform association among a plurality of objects appearing in a plurality of shot images with higher accuracy and with a lower processing load.

Therefore, in a case where the sensors 401, 402, . . . , and 40p are imaging devices, by mounting the image processing device 20 on each of the sensors 401, 402, . . . , and 40p, the crowd monitoring device 10 can efficiently perform, for example, automatic recognition of a specific object, creation of a three-dimensional map, or image search.

Next, operation of the crowd monitoring device 10 according to the first embodiment will be described.

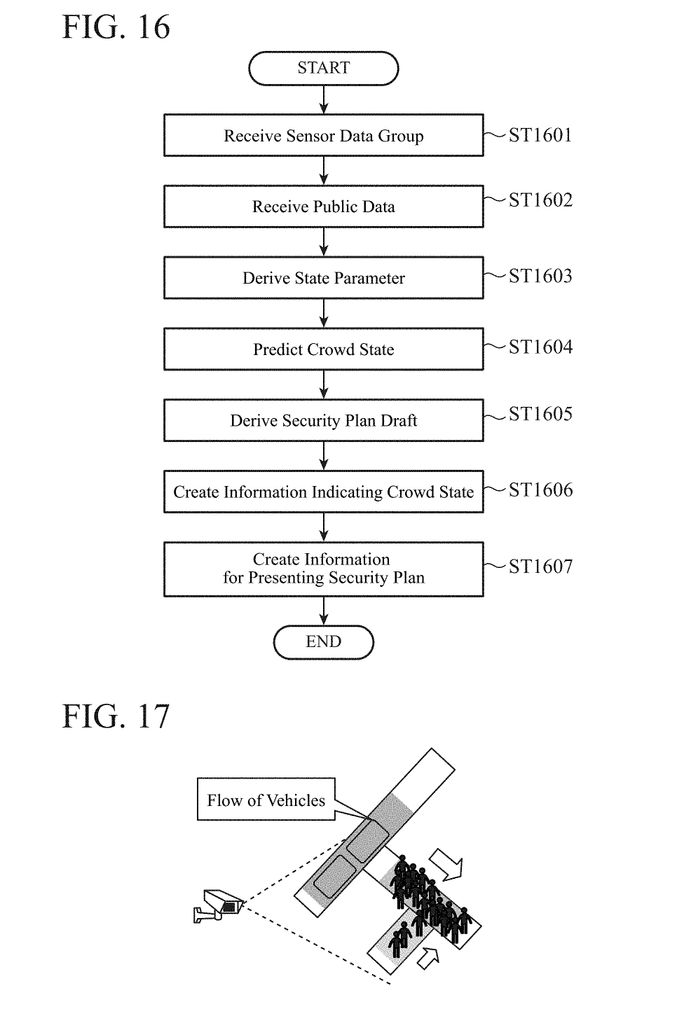

FIG. 16 is a flowchart for explaining the operation of the crowd monitoring device 10 according to the first embodiment of the present invention.

The sensor data receiving unit 11 receives sensor data distributed from the sensors 401, 402, . . . , and 40p (step ST1601). Here, since the sensors 401, 402, . . . , and 40p are the imaging devices as illustrated in FIG. 2, the sensor data receiving unit 11 acquires, as sensor data, image data associated with a descriptor, imaged by an imaging device. The sensor data receiving unit 11 outputs the received sensor data to the parameter deriving unit 13.

The public data receiving unit 12 receives public data publicly disclosed from the server devices 501, 502, . . . , and 50n via the communication network NW2 (step ST1602). The public data receiving unit 12 outputs the received public data to the parameter deriving unit 13.

The parameter deriving unit 13 acquires the sensor data output from the sensor data receiving unit 11 in step ST1601 and the public data output from the public data receiving unit 12 in step ST1602, and derives a state parameter indicating a crowd state feature quantity detected by the sensors 401, 402, . . . , and 40p on the basis of the acquired sensor data and public data (step ST1603). Here, the sensors 401, 402, . . . , and 40p are the imaging devices as illustrated in FIG. 2. As described above, each of the sensors 401, 402, . . . , and 40p analyzes a shot image, detects an object group appearing in the shot image, and transmits descriptor data indicating a spatial and geographical feature quantity of the detected object group to the crowd monitoring device 10. Incidentally, at this time, descriptor data indicating a visual feature quantity is also transmitted additionally.

As for operation in step ST1603, specifically, the crowd parameter deriving units 131, 132, . . . , and 13R of the parameter deriving unit 13 each analyze the sensor data output from the sensor data receiving unit 11 and the public data output from the public data receiving unit 12, and derive R types of state parameters (R is an integer equal to or more than 3) indicating a crowd state feature quantity. The parameter deriving unit 13 outputs the derived state parameter to the crowd state predicting unit 14, the security plan deriving unit 15, and the state presenting unit 16.

Incidentally, here, the crowd monitoring device 10 includes the public data receiving unit 12, and the parameter deriving unit 13 derives the state parameter using the public data received by the public data receiving unit 12, but the crowd monitoring device 10 does not have to include the public data receiving unit 12. In this case, the parameter deriving unit 13 derives a state parameter from the sensor data output from the sensor data receiving unit 11.

Here, the state parameter derived by the parameter deriving unit 13, that is, the crowd parameter deriving units 131, 132, . . . , and 13R will be described in detail.

Examples of the type of the state parameter include “crowd region”, “type of crowd action”, “crowd density”, “moving direction and speed of crowd”, “flow rate”, “extraction result of specific person”, and “result of extracting a person in a specific category”.

“Crowd region” is, for example, information for specifying a crowd region existing in target areas of the sensors 401, 402, . . . , and 40p.

As illustrated in FIG. 17, the crowd parameter deriving units 131, 132, . . . , and 13R perform clustering of movement features of an object group in a shot image, determine whether the object group is a crowd or a flow of vehicles from the state of movement in the clustered region, and specifies the region of the crowd.

The crowd parameter deriving units 131, 132, . . . , and 13R specify the “type of crowd action” for an object group in a region determined to be a crowd. Examples of the “type of crowd action” include “one way flow” in which a crowd flows in one direction, “counter flow” in which flows in opposite directions pass each other, and “stagnation” in which a crowd stays at a place. The “stagnation” can be classified into types such as “uncontrolled stagnation” indicating a state in which the crowd cannot move because of too high crowd density and “controlled stagnation” caused by stopping of the crowd in accordance with an instruction by an organizer.

The crowd parameter deriving units 131, 132, . . . , and 13R calculate “flow rate” for an object group for which the “type of crowd action” has been determined to be “one way flow” or “counter flow”. The “flow rate” is defined, for example, as a value (unit: number of people·m/s) obtained by multiplying a value of the number of people who have passed through a predetermined region per unit time by the length of the region.

The “extraction result of a specific person” includes information indicating whether a specific person exists in target areas of the sensors 401, 402, . . . , and 40p, and information regarding a trajectory obtained, in a case where a specific person exists, by tracing the specific person. This type of information can be used to create information indicating whether a specific person as a search target exists within a sensing range of the entire security supporting system 1, and is for example, information useful for searching for a lost child.

The “result of extracting a person in a specific category” includes information indicating whether a person belonging to a specific category exists in target areas of the sensors 401, 402, . . . , and 40p, and information regarding a trajectory obtained, in a case where a person belonging to a specific category exists, by tracing the specific person. Here, examples of the person belonging to a specific category include “a person of a specific age and sex”, “a weak person in traffic”, and “a person or a group that acts dangerously”, such as an infant, an elderly person, a wheelchair user, and a white cane user. This type of information is useful information for determining necessity of a special security system for the crowd.

In a case where the crowd monitoring device 10 includes the public data receiving unit 12 and the public data receiving unit 12 acquires public data, the crowd parameter deriving units 131, 132, . . . , and 13R can also derive a state parameter such as “subjective degree of congestion”, “subjective comfort”, “trouble occurrence situation”, “traffic information”, or “weather information” on the basis of the public data supplied from the server devices 501, 502, . . . , and 50n.

The crowd parameter deriving units 131, 132, . . . , and 13R may derive such a state parameter as described above on the basis of sensor data obtained from a single sensor, or by integrating a plurality of pieces of sensor data obtained from a plurality of sensors for use. In a case where sensor data obtained from a plurality of sensors is used, a sensor that transmits sensor data for deriving a state parameter may be a sensor group including the same type of sensor or a sensor group in which different types of sensors are mixed. In a case where a plurality of pieces of sensor data is integrated and used, it can be expected that the crowd parameter deriving units 131, 132, . . . , and 13R will derive a state parameter with higher accuracy than that in a case where single sensor data is used.

Return to the flowchart of FIG. 16.

The crowd state predicting unit 14 predicts a crowd state on the basis of the present or past state parameter output from the parameter deriving unit 13 in step ST1603 (step ST1604).

Specifically, the space crowd state predicting unit 141 predicts a crowd state of an area where no sensor is installed on the basis of the state parameter group output from the parameter deriving unit 13, creates “spatially predicted data”, and outputs the spatially predicted data to the security plan deriving unit 15 and the state presenting unit 16.

The time crowd state predicting unit 142 predicts a future crowd state on the basis of the state parameter output from the parameter deriving unit 13, creates “temporally predicted data”, and outputs the temporally predicted data to the security plan deriving unit 15 and the state presenting unit 16.

The time crowd state predicting unit 142 can estimate various pieces of information that determine a crowd state in an area where no sensor is installed or a future crowd state. For example, a future value of a parameter of the same type as a state parameter derived by the parameter deriving unit 13 can be created as “temporally predicted data”. Note that it is possible to arbitrarily define the extent of future for which a future crowd state can be predicted depending on a system requirement of the security supporting system 1. Similarly, the space crowd state predicting unit 141 can calculate a value of a parameter of the same type as a state parameter derived by the parameter deriving unit 13 as “spatially predicted data” for a crowd state in an area where no sensor is installed.

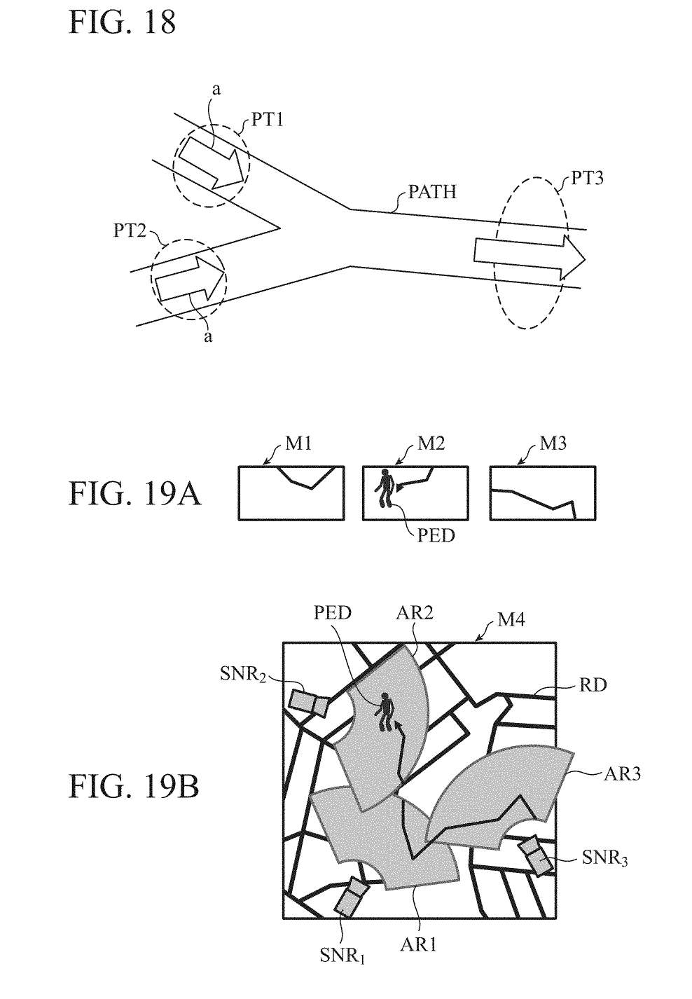

FIG. 18 is a diagram for explaining an example of a method for predicting a future crowd state and creating “temporally predicted data” by the time crowd state predicting unit 142 of the crowd state predicting unit 14 in the first embodiment.

As illustrated in FIG. 18, it is assumed that any one of the sensors 401, 402, . . . , and 40p is disposed in each of target areas PT1, PT2, and PT3 in a pedestrian path PATH. A crowd is moving from the target areas PT1 and PT2 toward the target area PT3.

The parameter deriving unit 13 derives crowd flow rates (unit: number of people·m/s) in the target areas PT1 and PT2, and outputs the flow rates to the crowd state predicting unit 14 as state parameter values. The time crowd state predicting unit 142 derives a predicted value of the flow rate in the target area PT3 toward which the crowd will move on the basis of the flow rate acquired from the parameter deriving unit 13. For example, it is assumed that a crowd in each of the target areas PT1 and PT2 at time T₁ moves in the direction of an arrow, a, as illustrated in FIG. 18 and the flow rate in each of the target areas PT1 and PT2 is F. At this time, in a case where a crowd behavior model that the moving speed of the crowd will be unchanged in the future is assumed and moving time of the crowd from each of the target areas PT1 and PT2 to the target area PT3 is t, the time crowd state predicting unit 142 predicts the flow rate in the target area PT3 at future time T+t as 2×F. Then, the time crowd state predicting unit 142 creates data of the flow rate 2×F in the target area PT3 at the future time T+t as “temporally predicted data”.

Return to the flowchart of FIG. 16.

The security plan deriving unit 15 derives a security plan draft on the basis of the state parameter output from the parameter deriving unit 13 in step ST1603 and the future crowd state information output from the crowd state predicting unit 14 in step ST1604, that is, on the basis of “temporally predicted data” and “spatially predicted data” (step ST1605). The security plan deriving unit 15 outputs information regarding the derived security plan draft to the plan presenting unit 17.

Specifically, for example, a typical pattern of a state parameter and predicted state data and a database of a security plan draft corresponding to the typical pattern are created in advance and stored, and the security plan deriving unit 15 derives a security plan draft using the database.

For example, in a case where the security plan deriving unit 15 acquires a state parameter group indicating that a certain target area is in a “dangerous state” and predicted state data from the parameter deriving unit 13 and the crowd state predicting unit 14, when a security plan draft associated with the state parameter indicating a “dangerous state” and predicted state data coinciding with the acquired predicted state data on the database “proposes to dispatch a security guard or to increase the number of security guards in order to organize stagnation of the crowd in the certain target area”, the security plan deriving unit 15 derives a security plan draft proposing to dispatch a security guard or to increase the number of security guards in order to organize stagnation of the crowd in the certain target area in a “dangerous state”.

In the first embodiment, examples of the “dangerous state” include a state in which “uncontrolled stagnation” of a crowd or “a person or a group that acts dangerously” is detected, and a state in which “crowd density” exceeds an allowable value.

On the basis of the state parameter output from the parameter deriving unit 13 in step ST1603 and the information regarding a crowd state output from the crowd state predicting unit 14 in step ST1604, that is, on the basis of “temporally predicted data” and “spatially predicted data”, the state presenting unit 16 generates visual data or acoustic data representing a past state, a present state, and a future state of a crowd in a user-friendly format (step ST1606). Incidentally, here, examples of the visual data represented in a user-friendly format include image and character information, and examples of the acoustic data represented in a user-friendly format include audio information.

The state presenting unit 16 transmits the generated visual data or acoustic data to the external apparatuses 71 and 72 and causes the external apparatuses 71 and 72 to output the visual data or the acoustic data as an image or audio.

The external apparatuses 71 and 72 receive the visual data or the acoustic data output from the state presenting unit 16, and output the visual data or the acoustic data as an image, a character, and audio from an output unit (not illustrated). Examples of the output unit include a display device such as a display and an audio output device such as a speaker.

FIGS. 19A and 19B are diagrams for explaining an example of an image in which visual data generated by the state presenting unit 16 is displayed on display devices of the external apparatuses 71 and 72.

In FIG. 19B, map information M4 representing a sensing range is displayed. The map information M4 indicates a road network RD, sensors SNR₁, SNR₂, and SNR₃ for sensing target areas AR1, AR2, and AR3, respectively, a specific person PED as a monitoring target, and a movement trajectory of the specific person PED (indicated by the black arrow line in FIG. 19).

FIG. 19A illustrates image information M1 of the target area AR1, image information M2 of the target area AR2, and image information M3 of the target area AR3.

As illustrated in FIG. 19B, the specific person PED moves across the target areas AR1, AR2, and AR3. Therefore, if it is assumed that a user sees only the image information M1, M2, and M3, it is difficult for the user to grasp a path through which the specific person PED has moved on a map unless the user understands arrangement of the sensors SNR₁, SNR₂, and SNR₃.

Therefore, the state presenting unit 16 generates visual data for mapping states appearing in the image information M1, M2, and M3 on the map information M4 of FIG. 19B and presenting the states on the basis of positional information regarding the sensors SNR₁, SNR₂, and SNR₃. By generating visual data for mapping the states in the target areas AR1, AR2, and AR3 in a map format and presenting the states in this manner and displaying the visual data on display devices of the external apparatuses 71 and 72, a user can intuitively understand a moving path of the specific person PED.

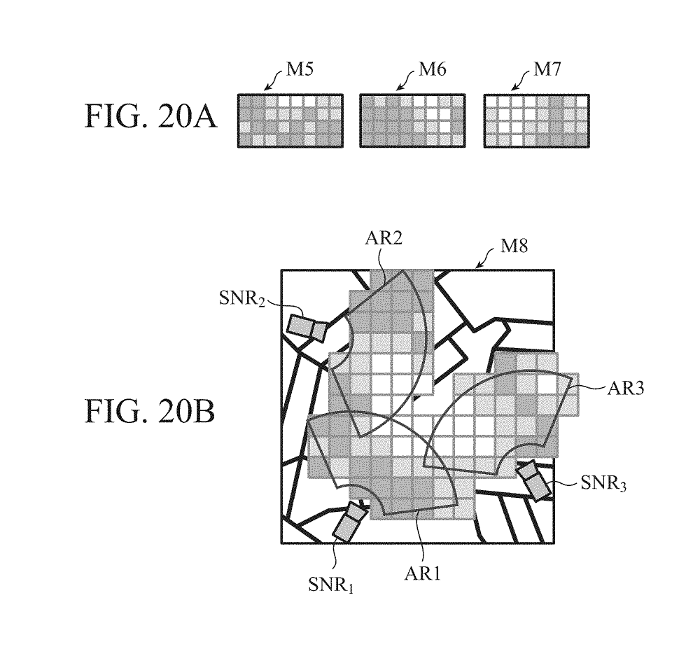

FIGS. 20A and 20B are diagrams for explaining another example of the image in which visual data generated by the state presenting unit 16 is displayed on display devices of the external apparatuses 71 and 72.

In FIG. 20B, map information M8 representing a sensing range is displayed. The map information M8 indicates a road network, sensors SNR₁, SNR₂, and SNR₃ for sensing target areas AR1, AR2, and AR3, respectively, and concentration distribution information representing the crowd density of a monitoring target.

FIG. 20A illustrates map information M5 representing the crowd density in the target area AR1 as a concentration distribution, map information M6 representing the crowd density in the target area AR2 as a concentration distribution, and map information M7 representing the crowd density in the target area AR3 as a concentration distribution. This example indicates that the brighter the color in a grid in an image indicated by the map information M5, M6, or M7 is, the higher the density is, and the darker the color is, the lower the density is. Also in this case, the state presenting unit 16 generates visual data for mapping results of sensing the target areas AR1, AR2, and AR3 on the map information M8 of FIG. 20B and presenting the results on the basis of positional information regarding the sensors SNR₁, SNR₂, and SNR₃. This allows a user to intuitively understand distribution of a crowd density.

In addition to the above example, for example, the state presenting unit 16 can generate visual data representing a time transition of a value of a state parameter in a graph format, visual data giving notice of occurrence of a “dangerous state” with an icon image, acoustic data giving notice of occurrence of a “dangerous state” with an alarm, and visual data representing the public data obtained from the server devices 501, 502, . . . , and 50n in a timeline format, and can cause the external apparatuses 71 and 72 to output the data.

The state presenting unit 16 can also generate visual data representing a future state of a crowd on the basis of the temporally predicted data of a future crowd state, output from the crowd state predicting unit 14, and can cause the external apparatuses 71 and 72 to output the visual data.

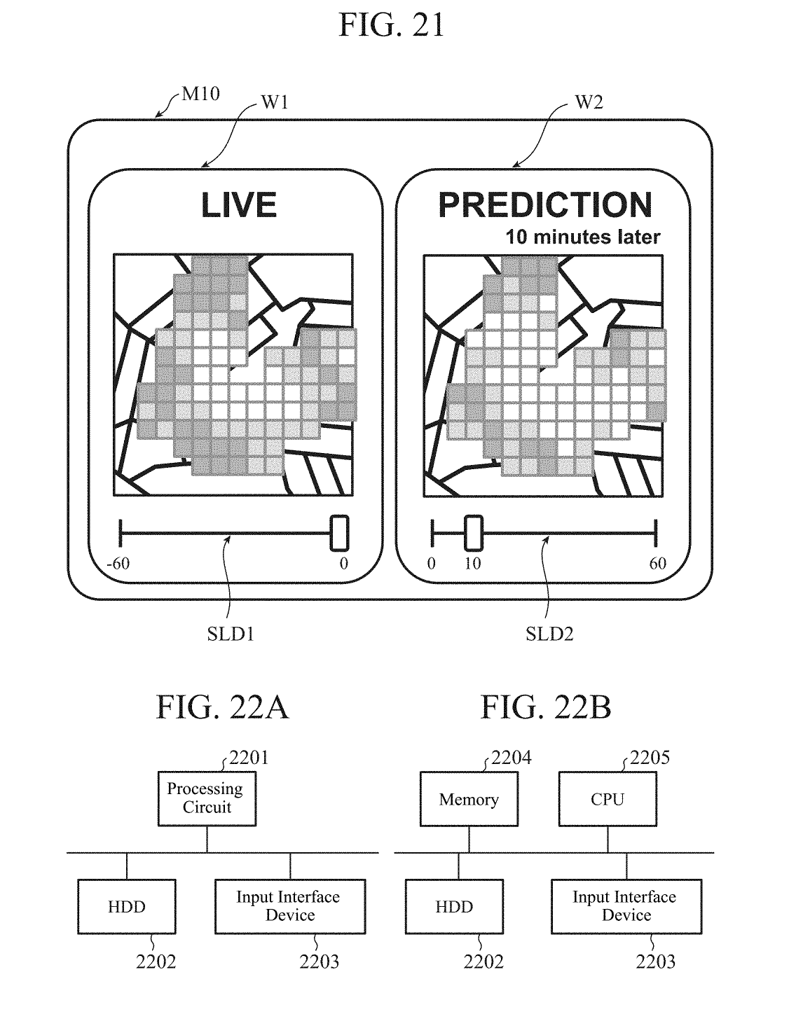

FIG. 21 is a diagram for explaining still another example of the image in which visual data generated by the state presenting unit 16 is displayed on display devices of the external apparatuses 71 and 72 in the first embodiment.

FIG. 21 illustrates image information M10 in which an image window W1 and an image window W2 are arranged in parallel. In FIG. 21, the image window W2 on the right side displays information regarding a future crowd state as a crowd state temporally later than information displayed in the image window W1 on the left side.

Meanwhile, in FIG. 21, the image window W1 on the left side displays visual data representing the past crowd state and the present crowd state generated on the basis of the state parameter output from the parameter deriving unit 13 by the state presenting unit 16.

By adjusting the position of a slider SLD1 through graphical user interface (GUI) of the external apparatuses 71 and 72, a user can cause the image window W1 to display a crowd state at the present or past designated time. In the example illustrated in FIG. 21, since the designated time is set to zero, the image window W1 displays the present crowd state in real time and displays the character title of “LIVE”.

As described above, the other image window W2 displays information regarding a future crowd state.

By adjusting the position of a slider SLD2 through the GUI, a user can cause the image window W2 to display a crowd state at a future designated time.

Specifically, for example, when the external apparatuses 71 and 72 accept operation of the slider SLD2 from a user, the state presenting unit 16 acquires the accepted operation information, creates visual data representing a value of a state parameter at the time designated by the operation of the slider SLD2 on the basis of the operation information, and causes display devices of the external apparatuses 71 and 72 to display the visual data. In the example illustrated in FIG. 21, since the designated time is set to be 10 minutes later, the image window W2 indicates a state 10 minutes later and displays the character title of “PREDICTION”. That is, the state presenting unit 16 creates visual data representing a value of a state parameter 10 minutes later and makes the visual data displayed. Note that the type and display format of a state parameter displayed in the image window W1 is the same as that displayed in the image window W2.

As described above, the state presenting unit 16 generates visual data representing the past crowd state, the present crowd state, and the future crowd state and causes the external apparatuses 71 and 72 to display the visual data on the basis of the state parameter output from the parameter deriving unit 13 and the information regarding the future crowd state output from the crowd state predicting unit 14. Therefore, by checking information displayed on display devices of the external apparatuses 71 and 72, a user can intuitively understand the present state and how the present state is changing.

Incidentally, FIG. 21 illustrates an example in which the image window W1 and the image window W2 are different from each other, but the present invention is not limited thereto. A single image window may be constituted by integrating the image windows W1 and W2, and the state presenting unit 16 may make visual data representing a value of a past, present, or future state parameter displayed in this single image window. In this case, the state presenting unit 16 is desirably configured so that a user can check a value of a state parameter at a designated time by switching the designated time with a slider. Specifically, for example, when the external apparatuses 71 and 72 accept designation of time from a user, the state presenting unit 16 acquires the accepted information, creates visual data representing a value of a state parameter at the designated time, and causes display devices of the external apparatuses 71 and 72 to display the visual data.

Return to the flowchart of FIG. 16.

The plan presenting unit 17 acquires information regarding the security plan draft output from the security plan deriving unit 15 in step ST1605 and generates visual data or acoustic data representing the acquired information in a user-friendly format (step ST1607). Incidentally, examples of the visual data represented in a user-friendly format include an image and character information, and examples of the acoustic data represented in a user-friendly format include audio information.

The plan presenting unit 17 transmits the generated visual data or acoustic data to the external apparatuses 73 and 74 and causes the external apparatuses 73 and 74 to output the visual data or the acoustic data as an image or audio.

The external apparatuses 73 and 74 receive the visual data or the acoustic data output from the plan presenting unit 17, and output the visual data or the acoustic data as an image, a character, and audio from an output unit (not illustrated). Examples of the output unit include a display device such as a display and an audio output device such as a speaker.

Examples of a method of for presenting a security plan include a method for presenting a security plan having the same contents to all users, a method for presenting a security plan for each target area to a user in a specific target area, and a method for presenting individual security plan for each individual.

That is, the plan presenting unit 17 may cause all the external apparatuses 73 and 74 to output information regarding the acquired security plan draft as it is. For example, the type of a security plan draft as an output target may be set for each of the external apparatuses 73 and 74 in advance, and the plan presenting unit 17 may control the external apparatuses 73 and 74 for outputting the information regarding the acquired security plan draft on the basis of the type set in advance. In addition, for example, a user ID possessing the external apparatuses 73 and 74 and a security plan to be supplied to the user may be set in advance, and the plan presenting unit 17 may control the external apparatuses 73 and 74 for outputting the information regarding the acquired security plan draft based on the information set in advance.

Incidentally, when the plan presenting unit 17 causes the external apparatuses 73 and 74 to output visual data or the like representing a security plan draft, the plan presenting unit 17 desirably generates acoustic data or the like of which a user can be actively notified together so that the user can immediately recognize presentation, for example, by causing the external apparatuses 73 and 74 to output a sound, or by vibrating the external apparatuses 73 and 74 when the external apparatuses 73 and 74 can be carried like a portable terminal.

As described above, the crowd monitoring device 10 causes the external apparatus 70 to output information indicating the past, present, and future crowd states and an appropriate security plan as useful information for security support according to a state predicted from the image data acquired from imaging devices as the sensors 401, 402, . . . , and 40p.

Incidentally, in the above description, the security plan deriving unit 15 derives a security plan draft, but the present invention is not limited thereto. For example, in a case where a security planner who is a user can check the visual data or the acoustic data representing the past, present, and future crowd states which the state presenting unit 16 has caused the external apparatuses 71 and 72 to output, the security planner can create a security plan draft by himself/herself on the basis of the information output from the external apparatuses 71 and 72.

In the above description, processing is performed in the order of step ST1601 and step ST1602, but the present invention is not limited thereto, and processing in step ST1601 and step ST1602 may be performed in the reverse order or at the same time.

In the above description, processing is performed in the order of step ST1604 and step ST1605, but the present invention is not limited thereto, and the processing in step ST1604 and step ST1605 may be performed in the reverse order or at the same time.

In the above description, processing is performed in the order of step ST1606 and step ST1607, but the present invention is not limited thereto, and the processing in step ST1606 and step ST1607 may be performed in the reverse order or at the same time.

FIGS. 22A and 22B are diagrams illustrating an example of a hardware configuration of the crowd monitoring device 10 according to the first embodiment of the present invention.

In the first embodiment of the present invention, the functions of the parameter deriving unit 13, the crowd state predicting unit 14, the security plan deriving unit 15, the state presenting unit 16, and the plan presenting unit 17 are implemented by a processing circuit 2201. That is, the crowd monitoring device 10 includes the processing circuit 2201 for predicting a crowd state in a target area on the basis of the received sensor data and public data, and controlling creation of data for outputting the predicted state, or data of a security plan based on the predicted state.

The processing circuit 2201 may be dedicated hardware as illustrated in FIG. 22A or a central processing unit (CPU) 2206 for executing a program stored in a memory 2204 as illustrated in FIG. 22B.

In a case where the processing circuit 2201 is dedicated hardware, for example, a single circuit, a composite circuit, a programmed processor, a parallel programmed processor, an application specific integrated circuit (ASIC), a field-programmable gate array (FPGA), or a combination thereof corresponds to the processing circuit 2201.

In a case where the processing circuit 2201 is a CPU 2205, the functions of the parameter deriving unit 13, the crowd state predicting unit 14, the security plan deriving unit 15, the state presenting unit 16, and the plan presenting unit 17 are implemented by software, firmware, or a combination of the software and the firmware. That is, the parameter deriving unit 13, the crowd state predicting unit 14, the security plan deriving unit 15, the state presenting unit 16, and the plan presenting unit 17 are implemented by a processing circuit such as the CPU 2205 or a system large-scale integration (LSI) for executing a program stored in a hard disk drive (HDD) 2202 or the memory 2204. It can also be said that the program stored in the HDD 2202, the memory 2204, or the like causes a computer to execute procedures or methods of the parameter deriving unit 13, the crowd state predicting unit 14, the security plan deriving unit 15, the state presenting unit 16, and the plan presenting unit 17. Here, for example, a nonvolatile or volatile semiconductor memory such as random access memory (RAM), read only memory (ROM), flash memory, erasable programmable read only memory (EPROM), or electrically erasable programmable read-only memory (EEPROM); a magnetic disk, a flexible disk, an optical disc, a compact disc, a mini disc, or a digital versatile disc (DVD) corresponds to the memory 2204.

Note that some of the functions of the parameter deriving unit 13, the crowd state predicting unit 14, the security plan deriving unit 15, the state presenting unit 16, and the plan presenting unit 17 may be implemented by dedicated hardware, and some of the functions thereof may be implemented by software or firmware. For example, the function of the parameter deriving unit 13 can be implemented by the processing circuit 2201 as dedicated hardware, and the functions of the crowd state predicting unit 14, the security plan deriving unit 15, the state presenting unit 16, and the plan presenting unit 17 can be implemented by reading out and executing a program stored in the memory 2204 by the processing circuit.

The public data receiving unit 12 and the sensor data receiving unit 11 are input interface devices 2203 that communicate with external apparatuses such as the sensors 401, 402, . . . , and 40p and the server devices 501, 502, . . . , and 50n.

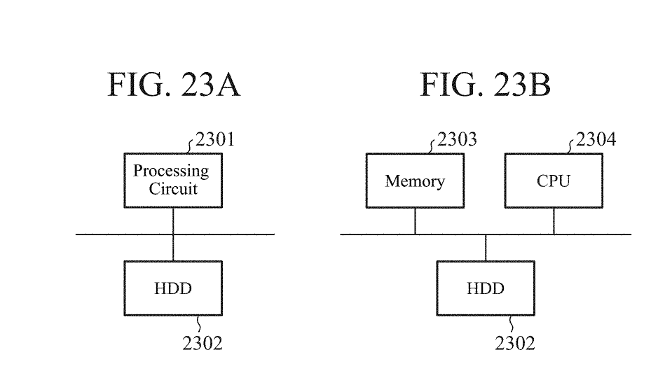

FIGS. 23A and 23B are diagrams illustrating an example of a hardware configuration of the image processing device 20 according to the first embodiment of the present invention.

In the first embodiment of the present invention, the functions of the image analyzing unit 21 and the descriptor generating unit 22 are implemented by the processing circuit 2301. That is, the image processing device 20 includes a processing circuit 2301 for acquiring image data imaged by an imaging device, analyzing the image data, and performing creation control for generating a descriptor.

The processing circuit 2301 may be dedicated hardware as illustrated in FIG. 23A or a central processing unit (CPU) 2306 for executing a program stored in a memory 2303 as illustrated in FIG. 23B.

In a case where the processing circuit 2301 is dedicated hardware, for example, a single circuit, a composite circuit, a programmed processor, a parallel programmed processor, an application specific integrated circuit (ASIC), a field-programmable gate array (FPGA), or a combination thereof corresponds to the processing circuit 2301.

In a case where the processing circuit 2301 is the CPU 2304, the functions of the image analyzing unit 21 and the descriptor generating unit 22 are implemented by software, firmware, or a combination of the software and the firmware. That is, the image analyzing unit 21 and the descriptor generating unit 22 are implemented by a processing circuit such as the CPU 2304 or a system large-scale integration (LSI) for executing a program stored in a hard disk drive (HDD) 2302 or the memory 2303. It can also be said that the program stored in the HDD 2302, the memory 2303, or the like causes a computer to execute procedures or methods of the image analyzing unit 21 and the descriptor generating unit 22. Here, for example, a nonvolatile or volatile semiconductor memory such as random access memory (RAM), read only memory (ROM), flash memory, erasable programmable read only memory (EPROM), or electrically erasable programmable read-only memory (EEPROM); a magnetic disk, a flexible disk, an optical disc, a compact disc, a mini disc, or a digital versatile disc (DVD) corresponds to the memory 2204.

Note that some of the functions of the image analyzing unit 21 and the descriptor generating unit 22 may be implemented by dedicated hardware, and some of the functions may be implemented by software or firmware. For example, the function of the image analyzing unit 21 can be implemented by the processing circuit 2301 as dedicated hardware, and the function of the descriptor generating unit 22 can be implemented by reading out and executing a program stored in the memory 2303 by the processing circuit.

The image processing device 20 includes an input interface device for accepting a shot image and an output interface device for outputting information regarding a descriptor.

Incidentally, in the security supporting system 1 according to the first embodiment, the parameter deriving unit 13, the crowd state predicting unit 14, the security plan deriving unit 15, the state presenting unit 16, and the plan presenting unit 17 are included in the single crowd monitoring device 10 as illustrated in FIG. 4, but the present invention is not limited thereto. The security supporting system may be configured by distributing and disposing the parameter deriving unit 13, the crowd state predicting unit 14, the security plan deriving unit 15, the state presenting unit 16, and the plan presenting unit 17 in a plurality of devices. In this case, the plurality of functional blocks only needs to be connected to one another through a local area communication network such as a wired LAN or a wireless LAN, a dedicated line network connecting bases, or a wide area communication network such as the Internet.

In the security supporting system 1 according to the first embodiment, positional information in the sensing ranges of the sensors 401, 402, . . . , and 40p is important. For example, it is important based on which position a state parameter such as a flow rate input to the crowd state predicting unit 14 has been acquired. Also in a case where the state presenting unit 16 performs mapping onto the map as illustrated in FIGS. 20A, 20B, and 21, positional information regarding a state parameter is indispensable.

A case is assumed in which the security supporting system 1 according to the first embodiment is configured temporarily and in a short period of time in accordance with holding of a large-scale event. In this case, it is necessary to install a large number of sensors 401, 402, . . . , and 40p in a short period of time and to acquire positional information regarding a sensing range. Therefore, positional information in the sensing range is desirably acquired easily.

As a means for easily acquiring positional information in a sensing range, it is possible to use spatial and geographical descriptors generated by the image processing device 20 and transmitted via the data transmitting unit 102. In a case of a sensor capable of acquiring an image, such as an optical camera or a stereo camera, by using spatial and geographical descriptors generated by the image processing device 20 mounted on the sensor, it is possible to easily derive a position to which a sensing result corresponds on a map. For example, in a case where a relationship between the spatial positions and the geographical positions of at least four points belonging to the same virtual plane among images acquired by a certain camera is recognized due to the parameter “GNSSInfoDescriptor” illustrated in FIG. 15, by performing projective transformation, it is possible to derive a position to which each position on the virtual plane corresponds on a map.

As described above, according to the first embodiment, it is unnecessary to prepare a database of a history of a flow of people in advance, and it is possible to easily grasp and predict a crowd state in the target area(s), on the basis of sensor data including descriptor data acquired from the sensors 401, 402, . . . , and 40p distributed and disposed in a single target area or a plurality of target areas.

In addition, it is possible to derive information indicating past, present, and future crowd states and an appropriate security plan, processed into a form easily understood by a user on the basis of the grasped or predicted state, and to present the information and the security plan to a security officer or a crowd who is a user as useful information for security support.

### Second Embodiment

In the first embodiment, the image processing device 20 is mounted on each of the sensors 401, 402, . . . , and 40p. That is, the image processing device 20 is disposed outside the crowd monitoring device 10.

In a second embodiment, an embodiment in which a crowd monitoring device 10a includes the image processing device 20 will be described.

Incidentally, also in the second embodiment, as in the first embodiment, the crowd monitoring device 10a is applied to the security supporting system 1 as an example.

Also in the security supporting system 1 in the second embodiment, as in the first embodiment, for example, the crowd monitoring device 10a presents information indicating past, present, and future crowd states and an appropriate security plan to a user as useful information for security support according to a crowd state estimated from image data acquired from imaging devices as the sensors 401, 402, . . . , and 40p.

The configuration of the security supporting system 1 including the crowd monitoring device 10a according to the second embodiment is similar to the configuration described with reference to FIG. 1 in the first embodiment, and therefore duplicate description will be omitted. The configuration of the security supporting system 1 according to the second embodiment is different from that according to the first embodiment only in that the crowd monitoring device 10 is replaced with the crowd monitoring device 10a.

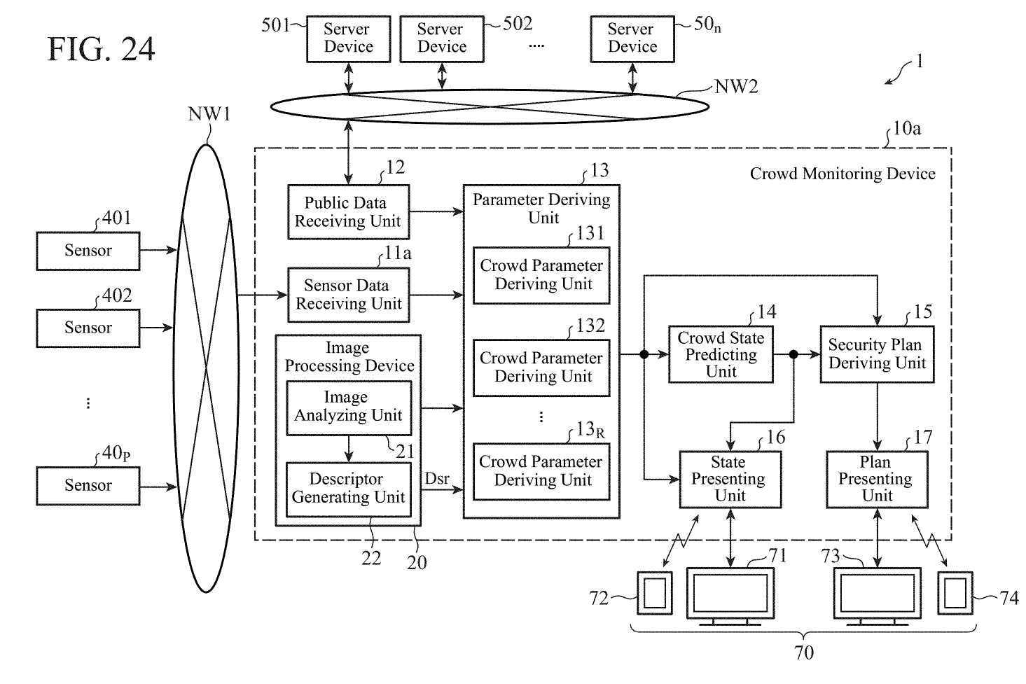

FIG. 24 is a configuration diagram of the crowd monitoring device 10a according to the second embodiment of the present invention.

The crowd monitoring device 10a illustrated in FIG. 24 is different from the crowd monitoring device 10 described with reference to FIG. 4 in the first embodiment only in that the image processing device 20 is mounted on the crowd monitoring device 10a and that there is a difference in operation of a sensor data receiving unit 11a, and the other components are similar to the components of the crowd monitoring device 10 of the first embodiment. Therefore, similar components are denoted by the same reference numerals, and duplicate description will be omitted.

In addition to having a similar function to the sensor data receiving unit 11 of the first embodiment, in a case where there is sensor data including a shot image among sensor data transmitted from the sensors 401, 402, . . . , and 40p, the sensor data receiving unit 11a extracts the shot image and outputs the shot image to the image analyzing unit 21 of the image processing device 20.

Here, as an example, the sensors 401, 402, . . . , and 40p are imaging devices. However, as described in the first embodiment, as the sensors 401, 402, . . . , and 40p, various types of sensors such as an optical camera, a laser distance measuring sensor, an ultrasonic distance measuring sensor, a sound collecting microphone, a thermo camera, a night vision camera, a stereo camera, a positioning meter, an acceleration sensor, and a vital sensor can be used. Therefore, in the second embodiment, the sensor data receiving unit 11a has a function of identifying sensor data transmitted from an imaging device and outputting a shot image to the image analyzing unit 21 in a case where the sensor data receiving unit 11a acquires sensor data from various types of sensors including an imaging device and a sensor other than the imaging device.

The operations of the public data receiving unit 12, the parameter deriving unit 13, the crowd state predicting unit 14, the security plan deriving unit 15, the state presenting unit 16, and the plan presenting unit 17 of the crowd monitoring device 10a according to the second embodiment are similar to the operations of the public data receiving unit 12, the parameter deriving unit 13, the crowd state predicting unit 14, the security plan deriving unit 15, the state presenting unit 16, and the plan presenting unit 17 of the crowd monitoring device 10 described in the first embodiment, respectively, and therefore duplicate description will be omitted.

The configuration of the image processing device 20 mounted on the crowd monitoring device 10a is similar to the configuration described with reference to FIGS. 2 and 3 in the first embodiment, and therefore duplicate description will be omitted.

The operation of the image processing device 20 is similar to the operation of the image processing device 20 described in the first embodiment. That is, in the second embodiment, the image analyzing unit 21 acquires a shot image from the sensor data receiving unit 11a and analyzes the shot image, and the descriptor generating unit 22 generates a spatial descriptor, a geographical descriptor, and a known descriptor according to the MPEG standard, and outputs descriptor data (indicated by Dsr in FIG. 24) indicating these descriptors to the parameter deriving unit 13. The parameter deriving unit 13 generates a state parameter on the basis of the descriptor data generated by the descriptor generating unit 22 of the image processing device 20.

The hardware configuration of the crowd monitoring device 10a according to the second embodiment is similar to the configuration described with reference to FIGS. 22A and 22B in the first embodiment, and therefore duplicate description will be omitted. Note that the sensor data receiving unit 11a has a similar hardware configuration to the parameter deriving unit 13, the crowd state predicting unit 14, the security plan deriving unit 15, the state presenting unit 16, and the plan presenting unit 17.

The hardware configuration of the image processing device 20 according to the second embodiment is similar to the configuration described with reference to FIGS. 23A and 23B in the first embodiment, and therefore duplicate description will be omitted.

As described above, according to the second embodiment, it is unnecessary to prepare a database of a history of a flow of people in advance as in the first embodiment, and it is possible to easily grasp and predict, on the basis of sensor data including descriptor data acquired from the sensors 401, 402, . . . , and 40p distributed and disposed in a single target area or a plurality of target areas, and public data obtained from the server devices 501, 502, . . . , and 50n on the communication network NW2, a crowd state in the target area(s).

In addition, it is possible to derive information indicating past, present, and future crowd states and an appropriate security plan, processed into a form easily understood by a user on the basis of the grasped or predicted crowd state, and to present the information and the security plan to a security officer or a crowd who is a user as useful information for security support.

### Third Embodiment

In the first embodiment, as an example of a method for predicting “flow rate” by the time crowd state predicting unit 142 of the state predicting unit 14, a method for assuming a crowd behavior model based on the flow rate of a crowd in a target area of a movement source and calculating the flow rate of a target area in a future movement destination by the time crowd state predicting unit 142 has been described (refer to FIG. 18 and the like).

In a third embodiment, another method for calculating a future flow rate by the time crowd state predicting unit 142 will be described.

The security supporting system 1 including the crowd monitoring device 10, the crowd monitoring device 10, and the hardware configurations of the crowd monitoring device 10, according to the third embodiment are similar to the configurations described with reference to FIGS. 1, 4, and 22 in the first embodiment, and therefore duplicate description will be omitted.

The operations of the sensor data receiving unit 11, the public data receiving unit 12, the crowd state predicting unit 14, the security plan deriving unit 15, the state presenting unit 16, and the plan presenting unit 17 of the crowd monitoring device 10 according to the third embodiment are similar to the operations of the sensor data receiving unit 11, the public data receiving unit 12, the crowd state predicting unit 14, the security plan deriving unit 15, the state presenting unit 16, and the plan presenting unit 17 of the crowd monitoring device 10 described in the first embodiment, respectively, and therefore duplicate description will be omitted.

In the third embodiment, the time crowd state predicting unit 142 of the parameter deriving unit 13 only illustrates an example of predicting “flow rate” by a method different from the method for predicting “flow rate” described in the first embodiment, and therefore only an example of the operation of the time crowd state predicting unit 142, different from the one exemplified in the first embodiment, will be described.

In the third embodiment, in a case where the parameter deriving unit 13 derives “flow rate” as a state parameter indicating a crowd state feature quantity detected by the sensors 401, 402, . . . , and 40p (refer to step ST1603 of FIG. 16 in the first embodiment), the parameter deriving unit 13 calculates “flow rate” of a crowd accurately at high speed when “type of crowd action” extracted for a crowd region existing in target regions of the sensors 401, 402, . . . , and 40p is “one way flow” or “counter flow”.

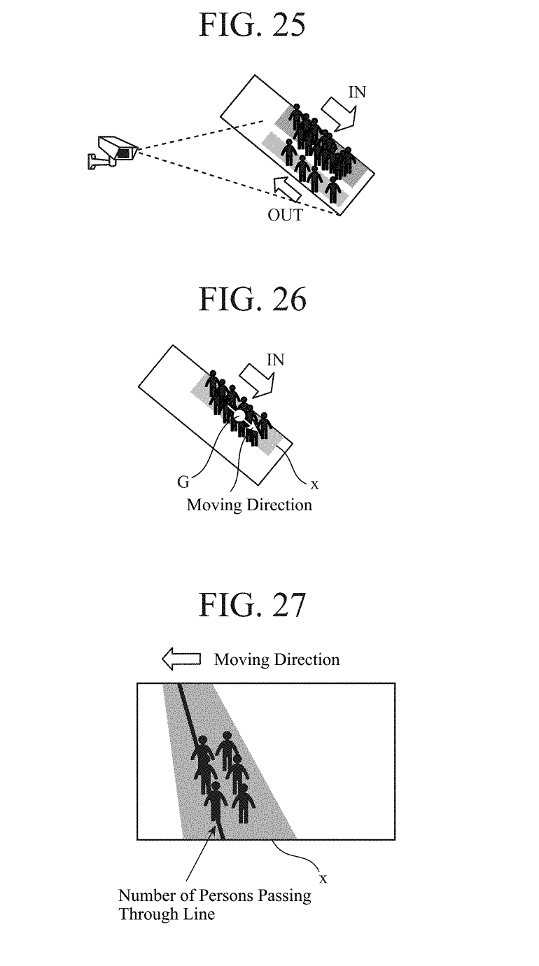

FIG. 25 is a diagram for explaining an example in which the time crowd state predicting unit 142 sets a moving direction of a crowd to two directions, detected as“type of crowd action” to be “counter flow” in the third embodiment.

In the third embodiment, opposing moving directions are referred to as “IN” and “OUT”, respectively. Note that either direction may be referred to as “IN” or “OUT”. In FIG. 25, a moving direction of a crowd away from an imaging device as a sensor, that is, a moving direction of a crowd toward the right in FIG. 25 is referred to as “IN”.

With reference to FIG. 25, a method for calculating the flow rate of a crowd detected as “counter flow”, for example, in an “IN” direction will be described.

The “flow rate” is calculated using the number of people who have passed through a predetermined region as defined in the first embodiment.

Generally, in a crowded situation where the density of a crowd in a certain space is equal to or more than a certain level, it is known that the density in the space is uniform because each person's freedom of walking is restricted and a person cannot overtake a preceding person. In the third embodiment, the time crowd state predicting unit 142 calculates the number of passing persons through a part of a crowd region detected as “counter flow” by using this property, and thereby can accurately estimate the number of passing persons through the entire region detected as “counter flow”.

As illustrated in FIG. 26, the time crowd state predicting unit 142 sets a region for calculating the number of passing persons as a flow rate calculating region (x in FIG. 26). The flow rate calculating region is a rectangular region set on the ground. A straight line of the rectangle in a longitudinal direction is, for example, orthogonal to a straight line passing through the center of gravity (G in FIG. 26) of a crowd region detected as the “IN” direction in a moving direction of a crowd.

Hereinafter, a specific method for calculating “flow rate” by the time crowd state predicting unit 142 in the third embodiment will be described.

As a method for calculating a flow rate in an “IN” direction in a flow rate calculating region in a shot image, an optical flow is calculated for each pixel in the flow rate calculating region, and the number of pixels having a flow obtained by moving a predetermined line in the flow rate calculating region in the “IN” direction is counted as the number of pixels, indicating the region of a person who has moved in the “IN” direction.

FIG. 27 is a diagram illustrating an example of an image of a flow rate calculating region in a shot image and a predetermined line in the flow rate calculating region in the third embodiment.

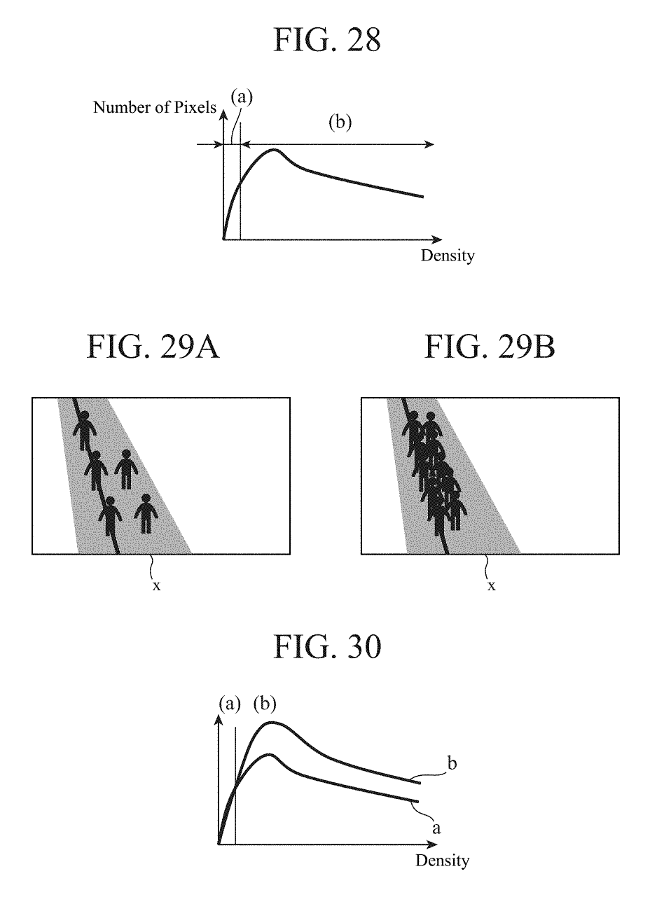

FIG. 28 is a diagram for explaining an example of a relationship between the number of pixels counted as having a flow obtained by moving a predetermined line in the “IN” direction and the density of a crowd in the third embodiment.

For example, as illustrated in FIG. 29A, in a case where the density of a crowd is low, since imaging is performed in a state in which there is no overlapping of people in a shotimage, the counted number of pixels and the density have a substantially proportional relationship to each other as illustrated in a section (a) in FIG. 28. Note that overlapping of people in a shot image is called occlusion.

Meanwhile, as the density of the crowd increases, as illustrated in FIG. 29B, overlapping of people occurs in a shot image, and therefore the rate of change in the counted number of pixels decreases and eventually becomes zero. As the density further increases, the moving speed of the crowd decreases, and therefore the rate of change in the counted number of pixels becomes a negative value. (refer to (b) of FIG. 28)

Therefore, the time crowd state predicting unit 142 calculates a value obtained by dividing the number of pixels having a flow that has moved across a predetermined line in a flow rate calculating region in the “IN” direction between certain frames by the number of pixels per person considering occlusion, and thereby calculates the number of people who have moved in the “IN” direction between the frames. This number is used as the number of people who have moved in the “IN” direction per unit time, that is, the crowd flow rate in the “IN” direction. Here, the number of pixels per person in the crowd considering occlusion is calculated by multiplying the number of pixels per person when it is assumed that there is no occlusion by a coefficient considering occlusion.

FIG. 30 illustrates an example of a relationship between a value obtained by dividing the counted number of pixels by the number of pixels per person, that is, the number of people who have moved in the “IN” direction when it is assumed that there is no occlusion and a flow rate in the “IN” direction.

In FIG. 30, a, represents a value obtained by dividing the counted number of pixels by the number of pixels per person, and b, represents a flow rate.

Note that the time crowd state predicting unit 142 can also calculate a flow rate in an “OUT” direction similarly. Even in a case where the number of moving directions of a crowd detected as “counter flow” is three or more, the time crowd state predicting unit 142 can calculate a flow rate for each direction by applying the above method to each direction.

In the third embodiment, the method for calculating “flow rate” for each moving direction of a crowd detected as “counter flow” by the time crowd state predicting unit 142 has been described, but calculation can be performed also for “one way flow” by a similar method.

Hereinafter, an example of a specific calculation means for calculating “flow rate” by the time crowd state predicting unit 142 will be described.

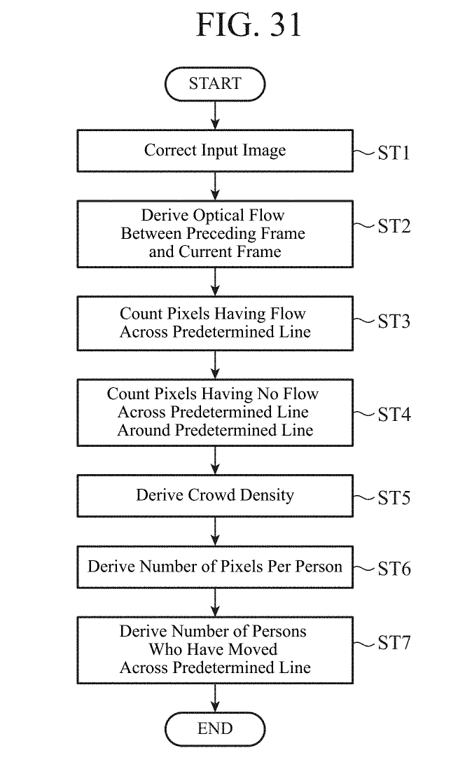

FIG. 31 is a processing flow diagram of crowd flow rate calculation processing executed for one image frame.

First, the time crowd state predicting unit 142 corrects an input image (step ST1). This correction includes processing of cutting out only a processing target region, correction of a brightness value, contrast, or the like of an image for implementing processing for optical flow estimation in a later stage with high accuracy, projective transformation to eliminate projective distortion of an image, geometric transformation to eliminate another distortion, and the like.

Next, the time crowd state predicting unit 142 derives an optical flow indicating movement of an object in an image between two frames of an immediately preceding image frame and a processing target image frame (step ST2). The optical flow is acquired for each pixel unit. It is only required to acquire the optical flow only around a predetermined line set in advance as a flow analyzing position.

Note that the optical flow acquired per pixel means a foreground region indicating a crowd and the moving quantity in the region. Therefore, the processing in this step may be replaced with a foreground extraction method on the basis of processing such as background difference or interframe difference and processing to determine the moving quantity in the foreground region by an arbitrary movement estimating method. The movement estimating method does not have to be a method for performing analysis using an image. For example, in a case where an input image has been compressed by a hybrid encoding method such as MPEG-2, H.264/AVC, or HEVC, movement may be estimated by using movement vector information included in the compressed stream as it is or by processing the movement vector information for use. Description will be made below on the premise that processing of deriving a flow per pixel by the optical flow is used.

Next, the time crowd state predicting unit 142 counts pixels having a flow across a predetermined line (step ST3). The number of pixels P_{nIN} across the predetermined line in the “IN” direction and the number of pixels P_{nOUT} across the predetermined line in the “OUT” direction are each individually counted.

Next, the time crowd state predicting unit 142 derives the number of pixels P_{nG} having no flow across a predetermined line around the predetermined line (step ST4). The pixel having a flow across the predetermined line means a pixel in a person region, and the pixel having no flow across the predetermined line means a pixel in a background region. In a case where a norm length average of a component orthogonal to the predetermined line in a flow across the predetermined line (in the “IN” direction and the “OUT” direction) is N [pixels] and the length of the predetermined line is L [pixel],

P_{nG}=N*L(P_{nIN}+P_{nOUT}) (1)

calculation can be performed with formula (1).

Next, the time crowd state predicting unit 142 estimates a crowd density D [person/m²] from a ratio O_{F} [%] of a person region in a region close to the predetermined line, calculated from P_{nIN}, P_{nOUT}, and P_{nG} (step ST5). O_{F} [%] is calculated with the following formula.

O_{F}={(P_{iIN}+P_{nOUT})/(P_{nIN}+P_{nOUT}+P_{nG})}*100 (2)

In this case, by recording values of P_{nIN}, P_{nOUT}, and P_{nG} acquired in the past plurality of frames and determining O_{F} [%] from a cumulative value for each of the P_{nIN}, P_{nOUT}, and P_{nG}, a more stable crowd density D with higher accuracy may be estimated. A relational formula between O_{F} and D is acquired in advance. The relational formula between O_{F} and D will be described later.

Next, the time crowd state predicting unit 142 derives the number of pixels P_{PED} per person from the crowd density D [people/m²] and scale information S [pixel/m] (step ST6). A relational formula between D and P_{PED} is acquired in advance. A relational formula among D, S, and P_{PED} will be described later.

Finally, by dividing P_{nIN} and P_{nOUT} by P_{PED}, the time crowd state predicting unit 142 derives the number of passing persons through the predetermined line in the frame for each of the “IN” direction and the “OUT” direction (step ST7). The time crowd state predicting unit 142 acquires the number of passing persons per unit time, that is, a parameter of a crowd flow rate, from information regarding elapsed time between frames.

By the above processing, it is possible to acquire the flow rate of a crowd passing through a predetermined line for each of the “IN” direction and the “OUT” direction.

Hereinafter, the relational formula between O_{F} and D will be described in detail.

The higher the density of a crowd is, the lower a ratio at which a background region located behind the crowd can be seen is. Therefore, it is expected that O_{F}, that is, a ratio occupied by a foreground region in a certain region will increase as the crowd density D increases.

However, how a crowd appears in a camera image depends on the shape/dimensions of each person in the crowd, the depression angle of the camera, and how the crowd is arranged with respect to the camera, and therefore it is necessary to specify these pieces of information in advance.

Each piece of information is defined as follows.

First, for the shape/dimensions of each person in a crowd, a person average model is used. This means that, for example, the shape/dimensions of each person may be defined as a cylindrical shape with a height h and a radius r from an average height h and a maximum radius r of an adult, or may be approximated with another simple shape. Alternatively, a 3D model of a person with more strictly average dimensions may be used. It is considered that the shape/dimensions of a crowd may vary depending on the nationality/age group of a target crowd, a change of clothing corresponding to climate/weather at the time of observation, or the like. Therefore, by having a plurality of models or making it possible to change a parameter for changing the dimensions/shape of a model, a model may be selected and adjusted in accordance with a situation.

In a case of a fixed camera, a depression angle θ of a camera can be a value measured in advance at the time of installation. Alternatively, the depression angle θ may be derived by analyzing a shot image. In the latter case, there is an advantage that even a moving camera can be applied.

Regarding how a crowd is arranged with respect to a camera, various patterns can exist as a positional relationship between crowds, and therefore a predetermined model is used.

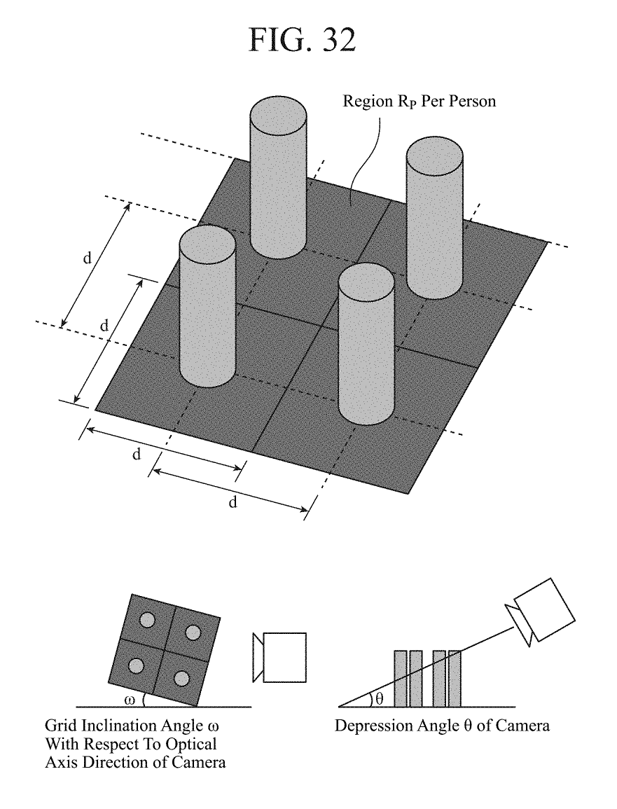

For example, as a model of a positional relationship of a crowd, a state in which persons are arranged in a grid shape is assumed as illustrated in FIG. 32. It is assumed that a person has a shape/dimensions determined as described above, and in this example, the person is approximated with a cylinder with a height of h [m] and a radius of r [m]. FIG. 32 is a diagram viewing four persons arranged in a grid shape from a camera with a depression angle θ while the grid is tilted by co from an optical axis direction of the camera. In this case, when a distance between the centers of persons aligned in a vertical or horizontal direction with respect to the crowd density D [people/m²] is represented by d [m], D and d have the following relationship.

$$d = \frac{1}{\sqrt{D}} \qquad ( 3 )$$

A region closest to a certain person is a square region of d×d centering on the person, and this region is represented by a region R_{P} per person.

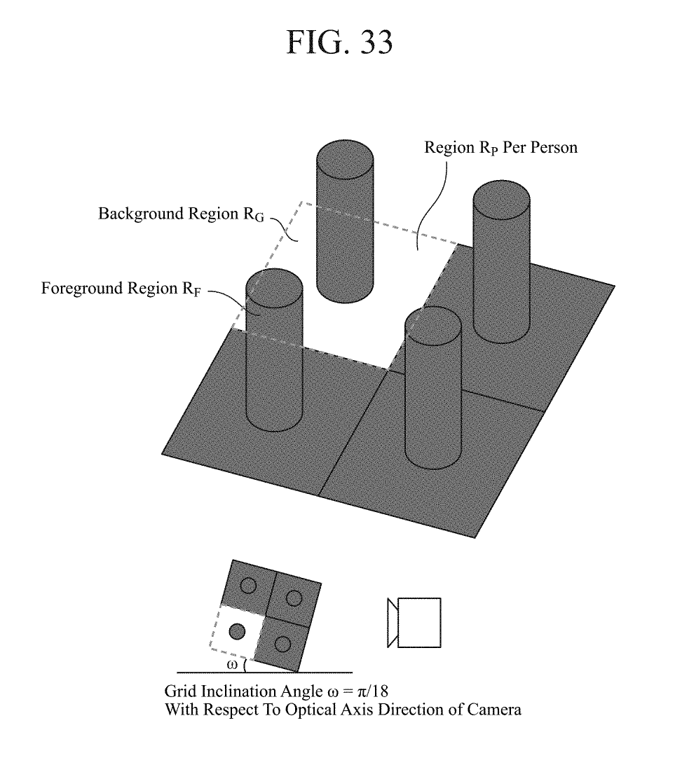

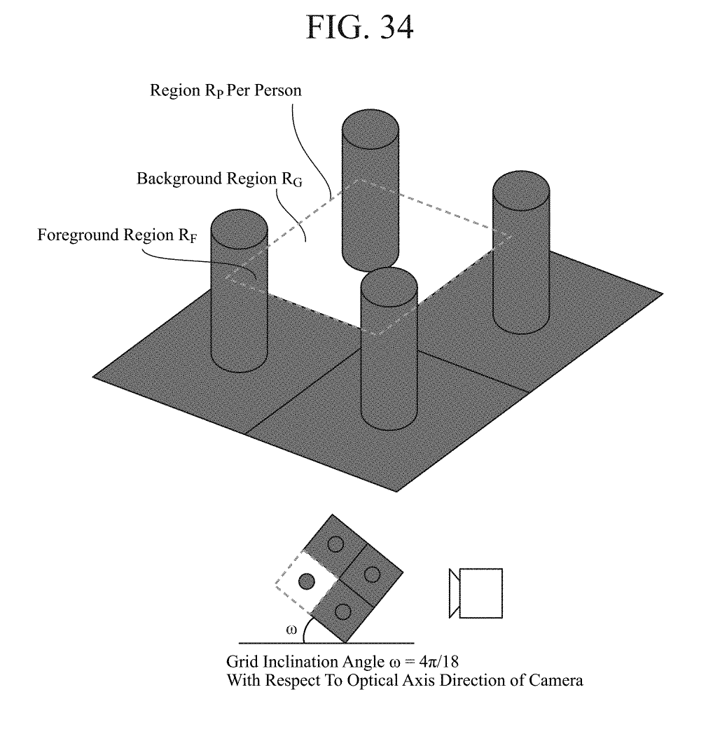

While definition is made as described above, O_{F} is defined as the area of the foreground region R_{F} (represented by black in R_{P}) in R_{G} with respect to the area of the region R_{P} per person existing on a far side from a camera in the present grid-shaped model. As can be seen from a comparison between FIGS. 33 and 34, since the appearance and the area of the foreground region R_{F} vary depending on the inclination w of the grid-shaped model with respect to an optical axis direction of the camera, it is desirable to use a value in terms of percentage obtained by calculating O_{F} values for various w values and averaging the O_{F} values as a final O_{F} value.

With this model, O_{F} is uniquely determined for the density D and the camera depression angle θ. By determining a relationship between the density D and the foreground region area ratio O_{F} for each camera depression angle θ, it is possible to estimate the crowd density D from the given camera depression angle θ and the calculated O_{F}.

Next, the relational formula between D and P_{PED} will be described in detail.

In a case where the scale information S is constant, the higher the density of a crowd is, the smaller the number of pixels P_{PED} per person in a certain crowd is. This is because the higher the density is, the smaller a distance within crowds is, and the higher a ratio at which a person on a far side of a camera is hidden by a person located in front is.

Also in the case of determining the relational formula between D and P_{PED}, as in the case of determining the relational formula between O_{F} and D, information regarding the shape/dimensions of each person in a crowd, the depression angle of a camera, the number of pixels of an object having a unit length in a camera image (scale information), and an arrangement state of a crowd with respect to a camera is required. These pieces of information are similar to the definition used for determining the relational formula between O_{F} and D.

In addition to these pieces of information, as described above, scale information indicating the length as a physical quantity corresponding to one pixel in a camera image is required.

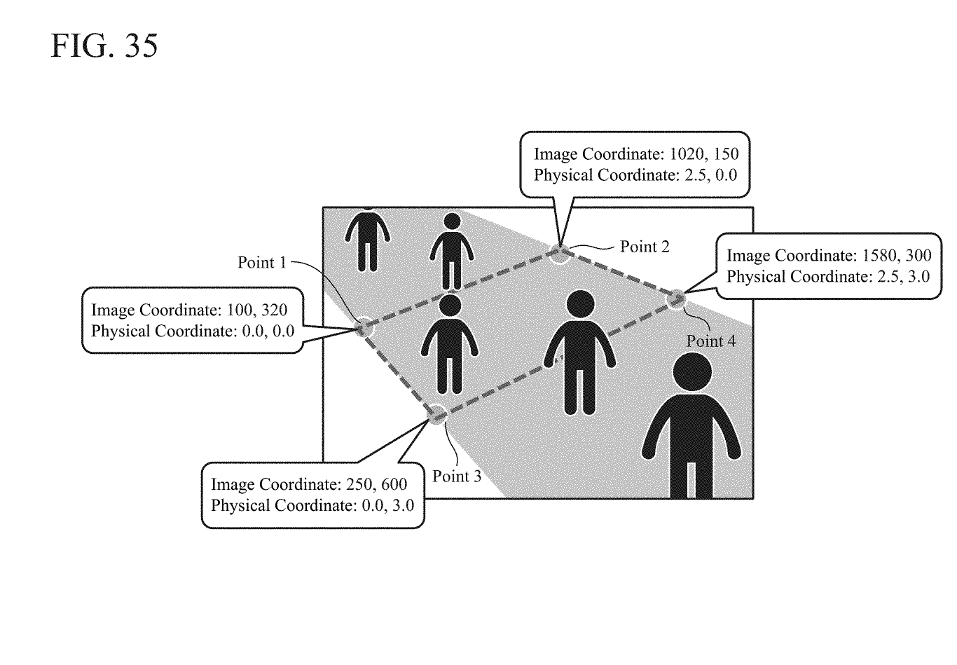

The scale information varies depending on the position of a person appearing in a camera image in accordance with a distance of a person from a camera, the angle of view of the camera, the resolution of the camera, the lens distortion of the camera, and the like. The scale information may be derived by the means described in the first embodiment, or by measuring an internal parameter indicating the lens distortion of a camera and an external parameter indicating a distance and a positional relationship between the camera and surrounding topography. Alternatively, as illustrated in FIG. 35, the scale information may be derived by manually designating a parameter for approximating a road surface in a measurement target region with a plane by a user. In the example illustrated in the drawing, Points 1 to 4 indicated by a set of an image coordinate and a physical coordinate are designated, and by performing projective transformation using these four points, an arbitrary coordinate in an image can be replaced with a physical coordinate on a plane on which the four points are located. Alternatively, a person appearing in an image or an object physical dimensions of which are known may be detected, and the scale information may be automatically estimated from the number of pixels of the object in the image. Alternatively, as an object is located farther from a camera, the moving quantity per unit time in an image is smaller. Therefore, from the magnitude of a flow of a plurality of objects in the image on the assumption that the flow has a uniform speed, distances of the objects from the camera may be estimated, and the scale information may be estimated. In a case where the assumed uniform speed is known, absolute scale information can be estimated. In a case where the assumed uniform speed is not known, relative scale information for each object can be estimated. A dense crowd has a feature that the moving speed is constant in a wide range, and therefore the scale information can be estimated with high accuracy with this group.

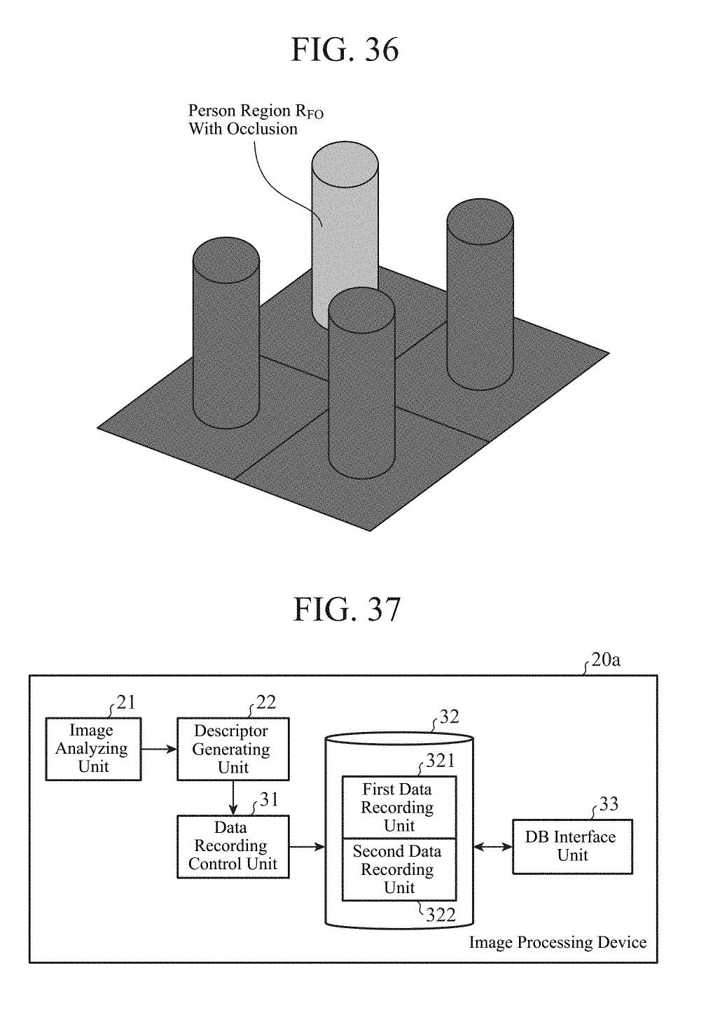

In this model, as illustrated in FIG. 36, in a case where a person region (shaded region in FIG. 35) in which a person region on a far side of a camera image is hidden by a person located in front, is represented by R_{FO}, the number of pixels of the R_{FO}, for example, in a case where the scale information S is S₀ [m/pixel], is represented by R_{PED}. Since the appearance and the area of the R_{FO} vary depending on the inclination w of this grid-shaped model with respect to an optical axis direction of the camera, R_{PED} values are calculated for various w values, and an average value of the R_{PED} values is desirably taken as a final R_{PED}.

With this model, R_{PED} is uniquely determined with respect to the density D and the camera depression angle θ. By determining a relationship between the density D and R_{PED} for each camera depression angle θ, it is possible to derive the number of pixels R_{PED} [pixel] per person considering occlusion from a given camera depression angle θ and an estimated D. Since this R_{PED} value is a value in a case where the scale information is S₀, a flow rate is calculated by correcting R_{PED} using a ratio between the actual scale information S and S₀.

As described above, according to the third embodiment, the parameter deriving unit 13 can accurately calculate the “flow rate” of a crowd at high speed.

In the image processing device 20 described in the above first to third embodiments, the descriptor generating unit 22 generates a spatial or geographical descriptor, and then outputs information regarding the descriptor via an output interface device to an external apparatus such as the data transmitting unit 102 or the parameter deriving unit 13, but the present invention is not limited thereto. The image processing device 20 may accumulate the information regarding the descriptor generated by the descriptor generating unit 22.

FIG. 37 is a diagram for explaining an example of a configuration in which the image processing device 20 can accumulate information regarding a descriptor.

As illustrated in FIG. 37, the image processing device 20a further includes a data recording control unit 31, a storage 32, and a data base (DB) interface unit 33 in addition to the configuration described with reference to FIG. 2 in the first embodiment.

The data recording control unit 31 stores image data acquired from a sensor as an imaging device via an input interface device and descriptor data generated by the descriptor generating unit 22 in association with each other in the storage 32.

The storage 32 stores image data and descriptor data in association with each other.

As the storage 32, for example, it is only required to use a large capacity recording medium such as an HDD or a flash memory.

The storage 32 includes a first data recording unit 321 for accumulating image data and a second data recording unit 322 for accumulating descriptor data. Note that the first data recording unit 321 and the second data recording unit 322 are disposed in the same storage 32 in FIG. 37, but the present invention is not limited thereto. The first data recording unit 321 and the second data recording unit 322 may be disposed in different storages separately.

The storage 32 is included in the image processing device 20a in FIG. 37, but the present invention is not limited thereto. For example, the storage 32 may be constituted by a single network/storage device or a plurality of network/storage devices disposed on a communication network, and the data recording control unit 31 may access an external network/storage device to accumulate image data and descriptor data.

The DB interface unit 33 accesses a database in the storage 32.

The image processing device 20a outputs information regarding a descriptor, acquired by accessing the storage 32 by the DB interface unit 33 to an external apparatus such as the data transmitting unit 102 or the parameter deriving unit 13 via an output interface.

Incidentally, in the security supporting system 1 of the above first to third embodiments, an object group of a crowd is configured to be a sensing target, but the present invention is not limited thereto. For example, a group of moving objects other than a human body, such as a living body including a wild animal and an insect, or a vehicle, may be an object group as a sensing target.

In the above first to third embodiments, as an example, the security supporting system 1 is exemplified as a crowd monitoring system to which the crowd monitoring device 10 is applied, and the crowd monitoring device 10 presents information indicating a crowd state and an appropriate security plan to a user as useful information for security support according to a state estimated from sensor data acquired from the sensors 401, 402, . . . , and 40p. However, a crowd monitoring system to which the crowd monitoring device 10 is applied is not limited to the security supporting system 1.

For example, the crowd monitoring device 10 may be applied to a system for researching the number of station users, may acquire sensor data from a sensor installed in a station, may predict the state of a station user, and may supply information regarding the predicted state. The crowd monitoring device 10 can be used in every situation where the state of a moving object is monitored and predicted on the basis of a sensor data group.

In the first embodiment, the crowd monitoring device 10 is configured as illustrated in FIG. 4. However, each of the crowd monitoring devices 10 and 10a includes the parameter deriving unit 13 and the crowd state predicting unit 14, and can thereby obtain the effect as described above.

In the second embodiment, the crowd monitoring device 10a is configured as illustrated in FIG. 24. However, the crowd monitoring device 10a includes the object detecting unit 2101, the scale estimating unit 2102, the parameter deriving unit 13, and the crowd state predicting unit 14, and can thereby obtain the effect as described above.

The invention of the present application can freely combine the embodiments to each other, modify any constituent element in each of the embodiments, or omit any constituent element in each of the embodiments within the scope of the invention.

### INDUSTRIAL APPLICABILITY

The crowd monitoring device according to the present invention is configured so as to be able to estimate the degree of congestion or a flow of a crowd in an environment in which the degree of congestion or the flow of a crowd cannot be grasped in advance, and therefore can be applied to a crowd monitoring device for predicting a flow of a crowd, a crowd monitoring system, and the like.

### REFERENCE SIGNS LIST

1: Security supporting system, 10, 10a: Crowd monitoring device, 11, 11a: Sensor data receiving unit, 12: Public data receiving unit, 13: Parameter deriving unit, 14: Crowd state predicting unit, 15: Security plan deriving unit, 16: State presenting unit, 17: Plan presenting unit, 20: Image processing device, 21: Image analyzing unit, 22: Descriptor generating unit, 31: Data recording control unit, 32: Storage, 33: DB interface unit, 70 to 74: External apparatus, 101: Imaging unit, 102: Data transmitting unit, 131 to 13R: Crowd parameter deriving unit, 141: Space crowd state predicting unit, 142: Time crowd state predicting unit, 211: Image recognizing unit, 212: Pattern storing unit, 213: Decoding unit, 321: First data recording unit, 322: Second data recording unit, 2101: Object detecting unit, 2102: Scale estimating unit, 2103: Pattern detecting unit, 2104: Pattern analyzing unit, 2201, 2301: Processing circuit, 2202, 2302: HDD, 2203: Input interface device, 2204, 2303: Memory, 2205, 2304: CPU.

1-12. (canceled)

13. A crowd monitoring device comprising:
a processor; and
a memory to store instructions, when executed by the processor, causing the processor to perform a process to:
derive, based on sensor data indicating an object group detected by a sensor and having information regarding a spatial feature quantity using a real space as a reference, a state parameter indicating a state feature quantity of the object group indicated by the sensor data; and
create, based on the state parameter derived by the parameter deriving process, spatially predicted data predicting a state of the object group in an area where the sensor is not installed.

14. A crowd monitoring device comprising:
a processor; and
a memory to store instructions, when executed by the processor, causing the processor to perform a process to:
derive, based on sensor data indicating an object group detected by a sensor and having information regarding a spatial feature quantity using a real space as a reference, a state parameter indicating a state feature quantity of the object group indicated by the sensor data; and
create, based on the state parameter derived by the parameter deriving process, temporally predicted data predicting a future state of the object group.

15. The crowd monitoring device according to claim 13, wherein
the sensor is an imaging device,
the sensor data is image data,
the process includes to:
detect an object group in an image indicated by image data collected from the imaging device; and
estimate, as scale information, a spatial feature quantity of the object group detected by the object detecting process using a real space as a reference, and
the parameter deriving process derives a state parameter indicating a state feature quantity of the object group detected by the object detecting process based on the scale information estimated by the scale estimating unit.

16. The crowd monitoring device according to claim 14, wherein
the sensor is an imaging device,
the sensor data is image data,
the process includes to:
detect an object group in an image indicated by image data collected from the imaging device; and
estimate, as scale information, a spatial feature quantity of the object group detected by the object detecting process using a real space as a reference, and
the parameter deriving process derives a state parameter indicating a state feature quantity of the object group detected by the object detecting process based on the scale information estimated by the scale estimating unit.
